(19) United States
(12) Patent Application Publication
(10) Pub. No.: US 2016/0135381 A1
(43) Pub. Date: May 19, 2016

(54) VEGETATED ROOF SYSTEMS, APPARATUSES AND METHODS

(71) Applicant: Furbish Company, LLC, Baltimore, MD (US)

(72) Inventors: Brad GARNER, Washington, DC (US); Michael FURBISH, Pasadena, MD (US); Whitney GRIFFIN, Baltimore, MD (US)

(73) Assignee: Furbish Company, LLC, Baltimore, MD (US)

(21) Appl. No.: 14/937,483

(22) Filed: Nov. 10, 2015

Related U.S. Application Data
(60) Provisional application No. 62/077,525, filed on Nov. 10, 2014.

(51) Int. Cl. A01G 1/00; E04D 11/00; E04D 13/00

(52) U.S. Cl. CPC A01G 1/005; E04D 13/00; A01G 1/007; E04D 11/002

(57) ABSTRACT

The disclosed subject matter broadly involves vegetated systems, apparatuses, and methods or portions thereof having structures and configurations to intentionally hold captured water gravitationally within and above a portion of a vegetated surface thereof. The vegetated system can be configured to periodically desiccate, dry or dry out, substantially completely or partially. Further, the vegetated system can be configured to allow the water to escape via evaporation, evapotranspiration, and transpiration.

### CROSS-REFERENCE TO RELATED APPLICATIONS

This application is based upon and claims the benefit of priority from U.S. provisional patent application 62/077,525, filed on Nov. 10, 2014, the entire contents of which are incorporated herein by reference.

### SUMMARY

The present invention and disclosed subject matter broadly relate to and broadly include vegetated roof or roof covering systems, apparatuses, and methods or portions thereof. However, embodiments of the disclosed subject matter are not necessarily limited to roof systems, with one or more embodiments being implemented or implementable, for example, on any surface that is impervious to water, such as on a “blue” surface (e.g., retrofitting thereof), a stone or concrete terrace or deck, pavement (e.g., portion of road or sidewalk), a sculpture, compacted earth, etc.

As a non-limiting example, one or more embodiments of the disclosed subject matter include a lightweight green roof system (e.g., less than 10-15 psf saturated weight) that can capture stormwater commensurate with common 2-year storms in the U.S. (i.e., from or over 0.7-1.4 gsf or 1″-2″ rain), for example, and that can provide stormwater filtration and nutrient reduction, as well as reliable stormwater management through retention and/or peak flow reduction even when environmental conditions slow evaporation and evapotranspiration.

One or more embodiments of the disclosed subject matter can include a vegetated roof covering having a structure and configuration to intentionally hold captured water gravitationally within and above a portion of a vegetated surface thereof Optionally, the vegetated roof covering is configured to periodically desiccate, dry or dry out, substantially completely or partially. Further, the vegetated roof covering can be configured to allow the water to escape (1) only via evaporation, only via evaporation and transpiration (i.e., evapotranspiration), or only via transpiration; (2) only via evaporation, then only via evaporation and transpiration, and then only via transpiration; or (3) only via evaporation and transpiration and then only via transpiration. Incidentally, transpiration can mean, generally speaking, the process of water movement through a plant and its evaporation from aerial or exposed parts.

Embodiments of the disclosed subject matter also can comprise a vegetated roof covering structure configured or constructed to intentionally store or retain (1) at least ½ inch of water over and in direct contact with a layer of moss of the vegetated roof covering structure; (2) any amount of water from ½ inch to 4 inches of water over and in direct contact with the layer of moss; or (3) no more than any amount of water from ½ inch to 4 inches of water over and in direct contact with the layer of moss. Optionally, the vegetated roof covering structure is configured to periodically desiccate, dry or dry out, completely or partially. Further, the vegetated roof covering structure can be configured to allow the water to escape (1) only via evaporation, only via evaporation and transpiration (i.e., evapotranspiration), or only via transpiration; (2) only via evaporation, then only via evaporation and transpiration, and then only via transpiration; or (3) only via evaporation and transpiration and then only via transpiration.

In one or more embodiments, the disclosed subject matter can comprise a vegetated roof covering system comprising a perennial vegetative surface, where the vegetated roof covering system has a dry weight of any value at or about 4 psf to at or about 10 psf, or at or about 1 psf to at or about 10 psf, for instance, and is configured or able to retain at least 1.0 or 1.2 gallons of water per square foot, no more than 2.0 gallons of water per square foot, or at or about 1.0 or 1.2 to at or about 2.0 gallons of water per square foot, for instance, where the vegetated roof covering system can allow gravitational water to be released as stormwater detention, and can be allowed to periodically desiccate to support the perennial vegetative surface.

Embodiments of the disclosed subject matter can also include a vegetated roof covering system having a dry weight of any value at or about 4 psf to at or about 10 psf or at or about 1 psf to at or about 10 psf, for instance, that is configured or able to retain at least 1.0 or 1.2 gallons of water per square foot, no more than 2.0 gallons of water per square foot, or at or about 1.0 or 1.2 to at or about 2.0 gallons of water per square foot, for example, where the vegetated roof covering can allow gravitational water to pond above a surface of perennial vegetation, and may be allowed to periodically desiccate.

In one or more embodiments of the disclosed subject matter a vegetated roof covering system can have a structure configured to retain at least 1.0 or 1.2 gallons of water per square foot, no more than 2.0 gallons of water per square foot, or at or about 1.0 or 1.2 to at or about 2.0 gallons of water per square foot, for instance, and can have dry components that as a group do not exceed one-inch in thickness, that do not exceed two inches in thickness, or that have a thickness of at or about one inch to at or about two inches, for instance.

One or more embodiments of the disclosed subject matter can also include a vegetated roof covering system comprising: a water catchment housing having an open top and a bottom wall and defining an internal volume; and a vegetative layer anchored to the bottom wall of the water catchment housing at an anchoring interface. The vegetated roof covering system can be configured to catch water using the water catchment housing and to intentionally temporarily retain gravitational water above and in direct contact with a portion of the vegetative layer, up to a maximum water fill level defined by the geometry of the water catchment housing. The vegetative layer can be either anchored directly to the bottom wall of the water catchment housing or anchored indirectly to the bottom wall of the water catchment housing via a root-permeable or anchor layer or section. Optionally, the vegetated roof covering system is configured to periodically desiccate, dry or dry out, completely or partially. Further, the vegetated roof covering system can be configured to allow the water to escape (1) only via evaporation, only via evaporation and transpiration (i.e., evapotranspiration), or only via transpiration; (2) only via evaporation, then only via evaporation and transpiration, and then only via transpiration; or (3) only via evaporation and transpiration and then only via transpiration.

One or more embodiments of the disclosed subject matter can also include a method comprising providing the vegetated roof covering/covering structure/covering system as disclosed and/or claimed herein. Optionally, the method can further comprise allowing receipt of water using the vegetated roof covering/covering structure/covering system; and allowing gravitational water to pond over the vegetated surface or layer.

One or more embodiments of the disclosed subject matter can also include a method of making vegetated roof covering systems, apparatuses, and portions thereof as disclosed and/or claimed herein.

### BRIEF DESCRIPTION OF THE DRAWINGS

The accompanying drawings, which are incorporated in and constitute a part of the specification, illustrate one or more non-limiting embodiments and, together with the description, explain these non-limiting embodiments. The accompanying drawings have not necessarily been drawn to scale. Any values dimensions illustrated in the accompanying graphs and figures are for illustration purposes only and may or may not represent actual or preferred values or dimensions. Where applicable, some or all features may not be illustrated to assist in the description of underlying features. In the drawings:

FIGS. 1A-1E are diagrammatic illustrations of a portion of a vegetated roof system according to an embodiment of the present disclosure, showing example representations of vegetation and a sequence of gravitational water escaping the system over time.

FIGS. 2A-2E are diagrammatic illustrations of a portion of a vegetated roof system according to another embodiment of the present disclosure, showing example representations of vegetation and a sequence of gravitational water escaping the system over time.

FIGS. 3A-3E are diagrammatic illustrations of a portion of a vegetated roof system according to yet another embodiment of the present disclosure, showing example representations of vegetation and a sequence of gravitational water escaping the system over time.

FIGS. 4A-4E are diagrammatic illustrations of a portion of a vegetated roof system according to another embodiment of the present disclosure, showing example representations of vegetation and a sequence of gravitational water escaping the system over time.

FIGS. 5A-5E are diagrammatic illustrations of a portion of a vegetated roof system according to an additional embodiment of the present disclosure, showing example representations of vegetation and a sequence of gravitational water escaping the system over time.

FIGS. 6A-6E are diagrammatic illustrations of a portion of a vegetated roof system according to yet another embodiment of the present disclosure, showing example representations of vegetation and a sequence of gravitational water escaping the system over time.

FIG. 7A is an overhead side perspective view of a geometrical configuration of a water catchment device or housing according to one or more embodiments of the disclosed subject matter.

FIG. 7B is a cross-sectional view of the water catchment device of FIG. 6A.

FIG. 8A is an overhead side perspective view of a geometrical configuration of a water catchment device or housing according to one or more embodiments of the disclosed subject matter.

FIG. 8B is a cross-sectional view of the water catchment device of FIG. 7A.

FIG. 9A is an overhead side perspective view of a geometrical configuration of a water catchment device or housing according to one or more embodiments of the disclosed subject matter.

FIG. 9B is a cross-sectional view of the water catchment device of FIG. 8A.

FIG. 10A is an overhead side perspective view of a geometrical configuration of a water catchment device or housing according to one or more embodiments of the disclosed subject matter.

FIG. 10B is a cross-sectional view of the water catchment device of FIG. 9A.

FIG. 11A is an overhead side perspective view of a geometrical configuration of a water catchment device or housing according to one or more embodiments of the disclosed subject matter

FIG. 11B is a cross-sectional view of the water catchment device of FIG. 10A.

FIG. 12 is a block diagram of a method according to one or more embodiments of the disclosed subject matter.

### DETAILED DESCRIPTION

The description set forth below in connection with the appended drawings is intended as a description of various embodiments of the disclosed subject matter and is not necessarily intended to represent the only embodiments in which the disclosed subject matter may be practiced. In certain instances, the description includes specific details for the purpose of providing an understanding of the disclosed subject matter. However, it will be apparent to those skilled in the art that the disclosed subject matter may be practiced without these specific details. In some instances, well-known structures and components may be shown in block diagram form in order to avoid obscuring the concepts of the disclosed subject matter.

Reference throughout the specification to “one embodiment,” “an embodiment,” or “various embodiments” means that a particular feature, structure, or characteristic described in connection with an embodiment is included in at least one embodiment of the subject matter disclosed. Thus, any appearance of the phrases “in one embodiment,” “in an embodiment,” “in various embodiments” in places throughout the specification is not necessarily referring to the same embodiment. Further, the particular features, structures or characteristics may be combined in any suitable manner in one or more embodiments. Additionally, it must be noted that, as used in the specification and the appended claims, the singular forms “a,” “an,” and “the” include plural referents unless the context clearly dictates otherwise. That is, unless clearly specified otherwise, as used herein the words “a” and “an” and the like carry the meaning of “one or more.” Further, it is intended that the embodiments of the disclosed subject matter cover modifications and variations. Further, it is to be understood that use of terms such as “left,” “right,” “top,” “bottom,” “front,” “rear,” “side,” “height,” “length,” “width,” “upper,” “lower,” “interior,” “exterior,” “inner,” “outer,” and the like that may be used herein, merely describe points of reference and do not limit the disclosed subject matter to any particular orientation or configuration. Furthermore, terms such as “first,” “second,” “third,” etc., merely identify one of a number of portions, components and/or points of reference as disclosed herein, and likewise do not limit the disclosed subject matter to any particular configuration or orientation.

As noted above, the present invention and the disclosed subject matter can broadly include or are broadly directed to vegetated roof or roof covering systems, apparatuses, and methods or portions thereof Of course, as noted above, embodiments of the disclosed subject matter are not necessarily limited to roof systems, with one or more embodiments being implemented or implementable, for example, on any surface that is impervious to water, such as on a “blue” surface (e.g., retrofitting thereof), a stone or concrete terrace or deck, pavement (e.g., portion of road or sidewalk), a sculpture, compacted earth, etc.

Generally speaking, vegetated systems, apparatuses, and methods or portions thereof according to embodiments of the disclosed subject matter can be used for rainwater or stormwater management.

Non-limiting advantages or benefits of vegetated systems, apparatuses, and methods or portions thereof according to embodiments of the disclosed subject matter include, but are not limited to, the ability to manage and treat non-point source run-off, including decreasing quantity and/or intensity of stormwater or rainwater runoff and increasing water quality of stormwater or rainwater runoff (e.g., lower total maximum daily limit (“TMDL”) of pollutants); increase pervious surfaces which can contribute toward evaporative cooling and reduce the urban heat island effect; increase rainwater or stormwater retention; reduce stormwater peak flow; stormwater or rainwater filtration; reduce or prevent wind scour; reduce or eliminate the need for nutrient or fertilizer inputs to the vegetation; strip and sequester Volatile Organic Compounds (“VOCs”) and other particulates; reduction in maintenance since embodiments may be self-sustaining; reduction in wasteload impact; and implicitly may have a relatively high Cation Exchange Capacity (“CEC”) based on its vegetation anchoring media. Additionally, embodiments of the disclosed subject matter can be in compliance with and exceed existing, anticipated or future industry or governmental standards or regulations, such as the Municipal Separate Storm Sewer System (“MS4”) and Forschungsgesellschaft Landschaftsentwicklung Landschaftsbau e.V. (“FLL”) Guidelines.

Generally speaking, the vegetated roof system may allow for flooding of a volumetric water-holding cavity or container such that water is intentionally allowed to pond or is otherwise intentionally retained above some or all of the vegetation and allowed to escape the system over time. Depending upon availability of water to supply the system (e.g., rain or stormwater conditions) and weather conditions in general (e.g., humidity, temperature, sunlight, wind speed, etc.) the water may be allowed to escape the system such that the system periodically desiccates or dries out, entirely, substantially, or partly over time (e.g., over a predetermined amount of time or predetermined time range). As will be discussed in more detail below, water may escape the system via evaporation (particularly surface evaporation), transpiration, or a combination of evaporation and transpiration. Optionally, water may be allowed to escape the system via active detention and/or passive detention. Thus, embodiments of the disclosed subject matter can provide a relatively high ambient recharge capacity (e.g., of approximately 90% of its maximum water holding capacity), as well as effective nutrient removal through stormwater filtration, stormwater retention and/or detention, and effective evaporative cooling through surface evaporation, evapotranspiration, and vegetative transpiration, for instance.

Vegetated roof systems according to embodiments of the disclosed subject matter can include one or more water catchment devices or housings that form a water-holding cavity, each having a bottom surface lined with a vegetative cover. The vegetative cover can be rooted or anchored to the bottom surface or wall of the water catchment device, either directly or indirectly. Optionally, the water catchment device or housing is allowed to periodically desiccate or dry. The water catchment device or housing can have an open top to receive water, for example, directly in the form of rainwater or stormwater. Alternatively, water can be received indirectly, for example, from a graywater source, from rainwater captured in a tank and supplied via a supply system (e.g., a detention system of the tank), and/or from a condensate source.

Water catchment devices according to embodiments of the disclosed subject matter can also have one or more upper containment edges, which are associated with corresponding sidewalls and/or end walls, and which may define a maximum amount of water that can be contained in the water catchment device. Optionally, the bottom surface or wall may be considered a sidewall and may also define a containment edge (e.g., in the case of a rounded or hemispherical bottom surface). As will be discussed in more detail below, the bottom surface may be at a decline, at an incline, have both inclined and declined portions, be entirely flat, have inclined, declined, and flat portions, or be curved, straight, convex, concave, or a combination thereof

Water catchment devices according to embodiments of the disclosed subject matter can be formed or otherwise have a structure or geometry to allow water to pond or be retained to a predetermined depth, for example, at any amount at or about ½ inch to at or about 4 inches, or not less than ½ inch to not greater than 4 inches. The depth of the water in the catchment device may have a uniform or non-uniform height from the bottom surface or wall of the water catchment device. The retained water can be above and in direct contact with the vegetated surface or vegetation line of the system. Depending upon the amount of water and/or the type of vegetation, some, all, or none of the vegetated surface or vegetation line may be covered with water.

Water catchment devices or housings according to embodiments of the disclosed subject matter can have any suitable geometrical configuration, such as a geometrical configuration in the form of one of a volumetric triangular prism, a volumetric three- or four-sided inverted pyramid, a volumetric cube, a volumetric non-square rectangle, half of or less than half of a volumetric sphere or one or more steps, or has one of a triangular or substantially triangular shape in a side view or a side cross-sectional view, has a square or substantially square shape in a side view or a side cross-sectional view, has a non-square rectangle or substantially non-square rectangle shape in a side view or a side cross-sectional view, has a v-shape or substantially v-shape shape in side view or side cross-sectional view, has an arc or substantially arc-shape in side or side cross-sectional view, is stepped in side or cross-sectional view, or is convex or concave in side or cross-sectional view, each with a completely or partially open top. Thus, geometrical configurations of water catchment devices or housings according to embodiments of the disclosed subject matter can have at least a bottom wall or surface and at least one upper containment edge. Each containment edge may be formed, for example, by simple dishing of a membrane and/or by side walls on some or all sides.

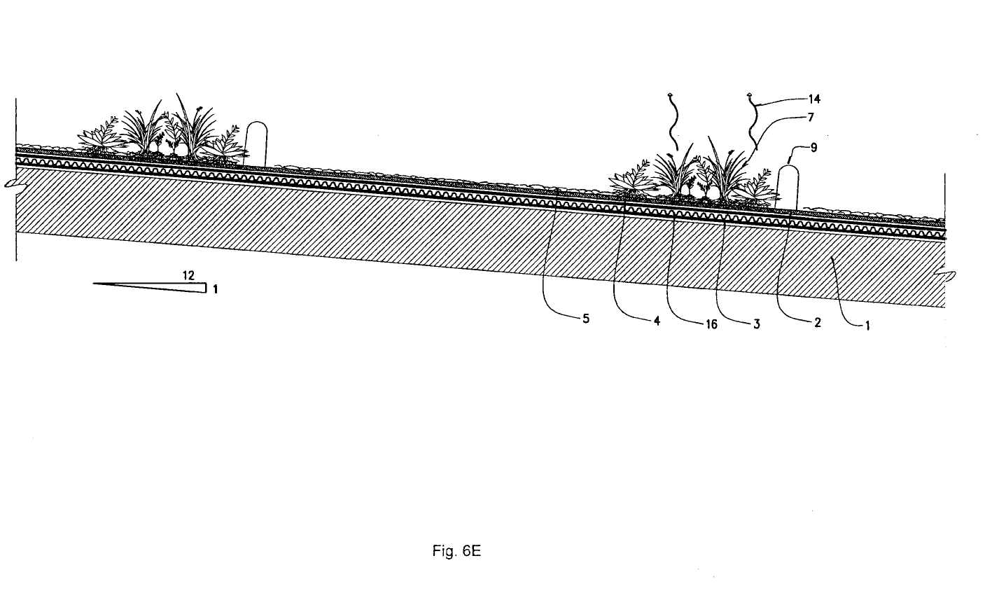

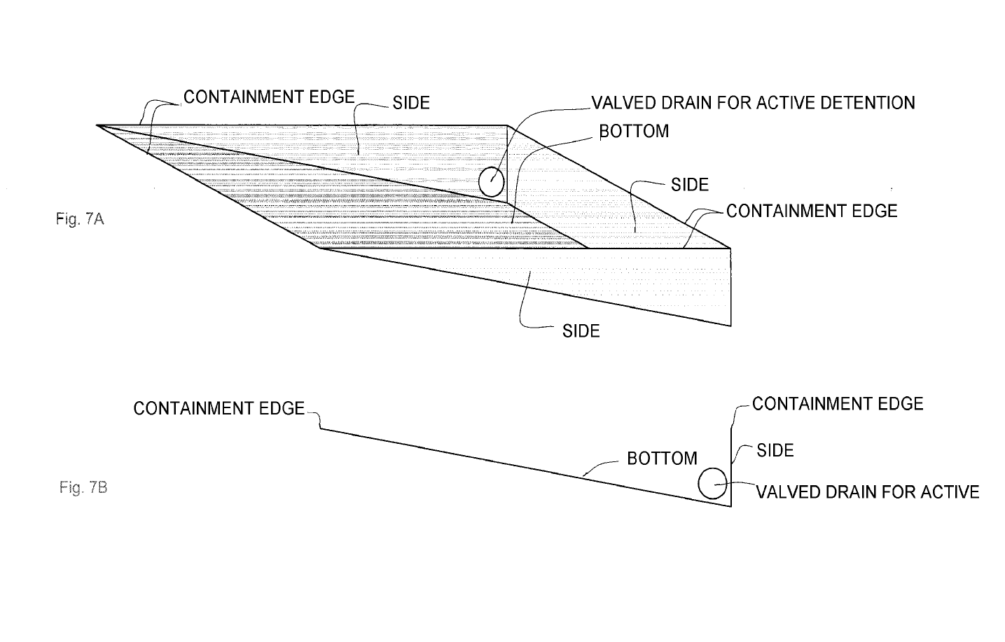

FIGS. 7A-7B, 8A-8B, 9A-9B, 10A-10B, and 11A-11B show, diagrammatically, a number of non-limiting examples of geometric configurations for the water catchment devices or housings according to embodiments of the disclosed subject matter.

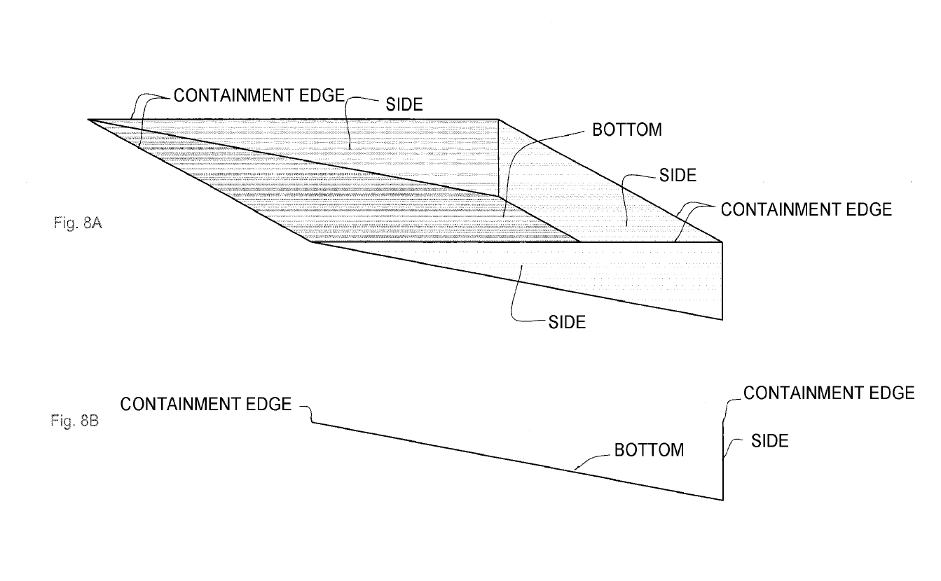

FIGS. 7A-7B and 8A-8B show, generally, water catchment devices or housings according to one or more embodiments of the disclosed subject matter, where the housings have a triangular prism or triangular volume geometric form. The water catchment devices of FIGS. 7A-7B and 8A-8B can include an open top, two side walls, a first end wall, an end opposite the first end wall, and a bottom surface or wall. The tops of the two sidewalls, the first end wall, and the end opposite the first end wall can define containment edges of the water catchment devices. Thus, the containment devices can hold a maximum water level up to the containment edges. Optionally, the end opposite the first end wall may have a relatively small second end wall, opposite the first end wall, and parallel or angled from the first end wall, which can form a corresponding containment edge.

Additionally, the water catchment devices or housings of FIGS. 7A-7B and 8A-8B show the bottom surface or wall at an angle or decline from left to right. Thus, the water catchment devices according to FIGS. 7A-7B and 8A-8B form a deep end and a shallow end. As a non-limiting example, the deep end can hold a water depth of no more than at or about 4 inches of water, and the shallow end can hold a water depth of no more than at or about ½ inch of water. Additionally, in the example illustrated in FIGS. 7A-7B and 8A-8B, and in triangular prism or triangular volume geometric form configurations generally, the water catchment devices can hold 1.0 g/sf of water, for example.

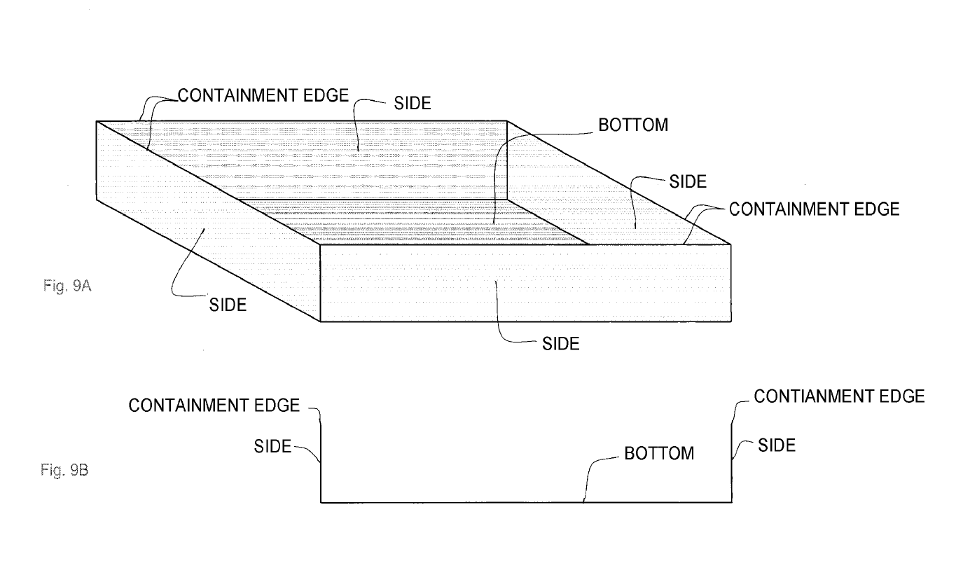

FIGS. 9A-9B show, generally, a water catchment device or housing according to one or more embodiments of the disclosed subject matter, where the housing has a cube or non-square cube geometric form. The water catchment device of FIGS. 9A-9B can include an open top, four side walls, and a bottom surface or wall. The tops of the sidewalls can define containment edges of the water catchment device. Thus, the containment device can hold a maximum water level up to the containment edges. As a non-limiting example, the maximum water level, as defined by the containment edges, can be no more than at or about ½ inch of water to no more than at or about 4 inches of water. Additionally, in the example illustrated in FIGS. 9A-9B, and in rectangular, rectangular volume geometric form, or flat-bottom configurations generally, the water catchment devices can hold 2.0 g/sf of water, for example.

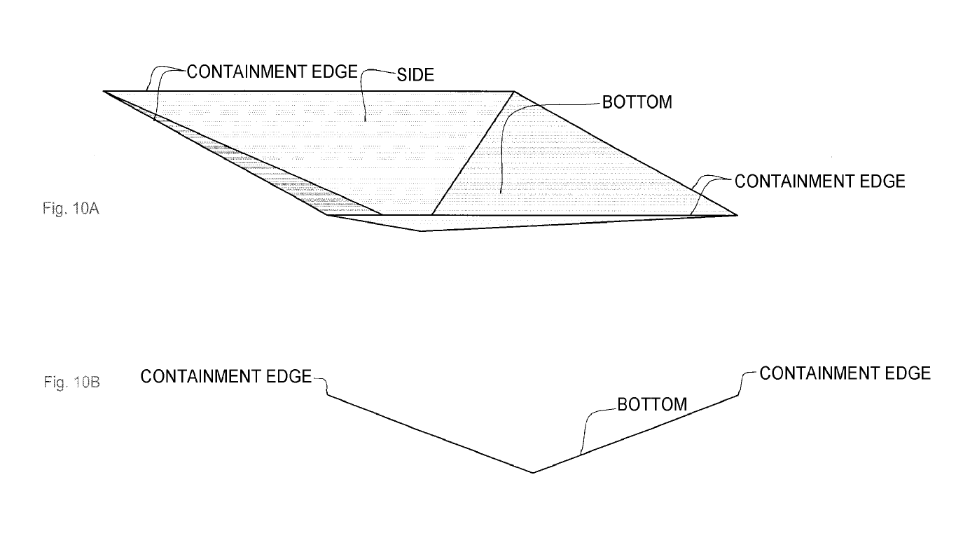

FIGS. 10A-10B show, generally, a water catchment device or housing according to one or more embodiments of the disclosed subject matter, where the housing has an inverted pyramid geometric form. The water catchment device of FIGS. 10A-10B includes an open top, four side walls, which also serve as the bottom surface/wall or surfaces/walls. The tops of the sidewalls/bottom walls can define containment edges of the water catchment device. Thus, the containment device can hold a maximum water level up to the containment edges. Further, the containment edges can be at a same height or substantially a same height. As a non-limiting example, the maximum water level, as defined by the containment edges, can be no more than at or about ½ inch of water to no more than at or about 4 inches of water. Alternatively, rather than the sidewalls/bottom walls coming together at a point, one or more alternative embodiments of the disclosed subject matter can have a flat or non-sloped bottom wall or surface meeting the four sidewalls.

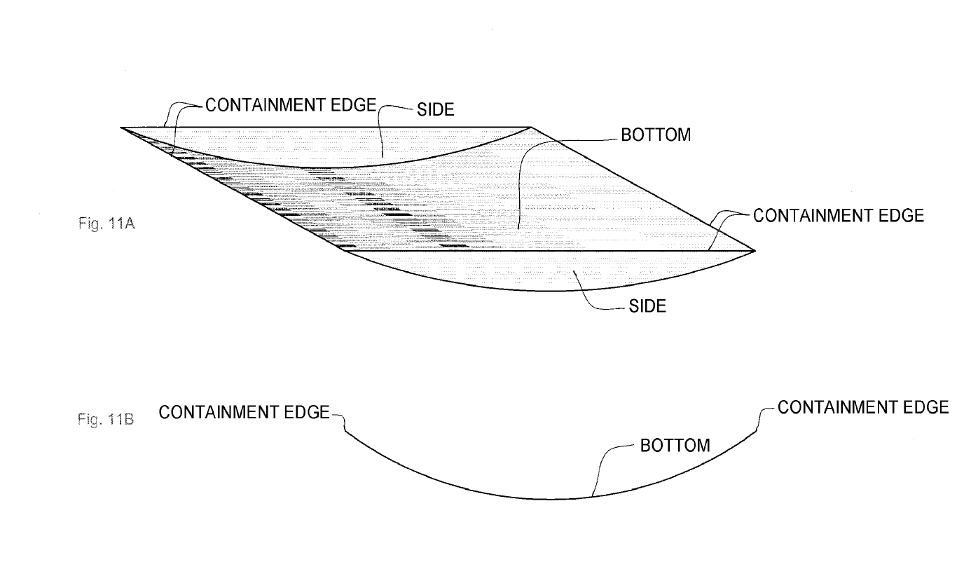

FIGS. 11A-11B show, generally, a water catchment device or housing according to one or more embodiments of the disclosed subject matter, where the housing is in the form of a portion of a sphere or hemisphere. The water catchment device of FIGS. 11A-11B includes an open top, two slanted or vertical side walls, and a bottom wall, which may also be interpreted as defining opposing end walls. The tops of the sidewalls and ends of the bottom wall can define containment edges of the water catchment device. Further, the containment edges can be at a same height or substantially a same height. Thus, the containment device can hold a maximum water level up to the containment edges. As a non-limiting example, the maximum water level, as defined by the containment edges, can be no more than at or about ½ inch of water to no more than at or about 4 inches of water. Alternatively, rather than the bottom wall being curved along its entire length, a middle portion thereof, for example, may be flat or non-curved.

As noted above, the illustrations of FIGS. 7A-7B, 8A-8B, 9A-9B, 10A-10B, and 11A-11B are not intended to limit the structure or geometric shape of the catchment devices or enclosures according to embodiments of the disclosed subject matter.

For the sake of illustrating the geometric configuration of the containment devices or housings, FIGS. 7A-7B, 8A-8B, 9A-9B, 10A-10B, and 11A-11B do not show the vegetative cover and do not expressly show the construction of the bottom wall or media that can be part of, on or over the bottom wall. However, vegetative covers and media according to the disclosed subject matter can be arranged on or over and/or fixed to (directly or indirectly) the bottom wall or surface. As noted earlier, a vegetative cover can be rooted or anchored to the bottom surface or wall of the water catchment device, either directly or indirectly, so as to define a rooting or anchoring interface.

According to one or more embodiments of the disclosed subject matter, water catchment devices can include a waterproof membrane, such as thermoplastic polyolefin (“TPO”), polyvinyl chloride (“PVC”), ketone ethylene ester (“KEE”), hot rubberized asphalt (“HRA”), modified bitumen, ethylene propylene diene monomer (“EPDM”), or other membranes used in roofing or waterproofing construction. Alternately, water catchment devices according to embodiments of the disclosed subject matter may be formed of water-tight materials, such as high-density polyethylene (“HDPE”), low-density polyethylene (“LDPE”), aluminum, or stainless steel, and positioned over the roofing or waterproofing materials.

The bottom surface of the water catchment devices can allow anchorage of vegetation directly or indirectly, as noted above. For example, the roofing membrane may have a textured surface that allows vegetation, such as moss, to anchor directly to the bottom surface of the catchment device or housing. Optionally or alternatively, in one or more embodiments of the disclosed subject matter, vegetation, in a vegetation cover or layer for instance, may be anchored to a root-permeable layer of material above the bottom surface of the catchment device. Optionally, such root-permeable layer may be permanently or substantially permanently coupled to the bottom surface of the catchment device. Alternatively, such root-permeable layer may be removable from the bottom surface of the catchment device.

Vegetation that makes up the vegetation layer or cover according to embodiments of the disclosed subject matter can be comprised of, can be comprised essentially of can consist of, can consist essentially of, or can be selected from the group consisting of at least one of one or more types or varieties of moss, one or more types or varieties of lichen, and/or one or more types or varieties of non-vascular plants. Optionally or alternatively, vegetation that makes up the vegetation layer or cover according to embodiments of the disclosed subject matter can be comprised of can be comprised essentially of, can consist of, can consist essentially of, or can be selected from the group consisting of at least one of one or more types or varieties of moss, one or more types or varieties of lichen, one or more types or varieties of non-vascular plants, and/or one or more types or varieties of vascular plants. More specific examples include at least one of one or more types or varieties of moss, one or more types or varieties of lichens, one or more types or varieties of quillwort, Phacetia dubia, Sedum pusillum, Opuntia, Selanginella rupestris, Diamorpha Smallii or Elf Orpine, one or more types or varieties of bryophytes, one or more types or varieties of succulents, one or more types or varieties of cacti, one or more types or varieties of grasses, one or more types or varieties of sedges, and/or one or more types or varieties of wildflowers. As noted above, in various embodiments, the vegetation can live through and survive periodic desiccation of its surroundings and/or environment (including vegetated systems or devices or portions thereof (e.g., media or aggregate) according to embodiments of the disclosed subject matter).

The vegetation can be homogeneous or heterogeneous in terms of types or varieties of plants. For example, moss only may be implemented over the entire bottom surface of the containment device or, alternatively, moss only may be implemented at a portion of the bottom surface of the containment device (e.g., associated with a relatively shallower portion) and taller, vascular plants may be implemented at another portion of the bottom surface of the containment device (e.g., associated with a relatively shallower portion). Thus, optionally, in embodiments of the disclosed subject matter, leaves and stems of vegetation may grow below the ponding depth of the catchment device, such that vegetation is submerged or partially submerged when the devices are filled to capacity with water, and leaves and stems of vegetation may also extend above the surface of water at the maximum ponding depth. Further, vegetation according to embodiments of the disclosed subject matter can tolerate both temporary inundation and periodic desiccation.

The media, which can be above or over the roofing membrane, can be comprised of a thin layer of water-absorbent or water-permeable synthetic material, such as capillary fabric, industrial felt, mineral wool, fleece, tangled monofilament, or foam. Optionally or alternatively, the media can be comprised of a thin layer of organic material, such as bark, mulch, coco husks, peat, or humus. Optionally or alternatively, the media may be a thin layer of mineral material such as soil, aggregate, rock, sand, scoria, pebbles, pumice, crushed brick, crushed asphalt, or construction debris. Thus, in one or more embodiments, the media may be a combination of synthetic, mineral and organic materials, for example, layered or intermixed. Alternatively, the media may consist of or comprise only the synthetic material, only mineral materials, only organic materials, or only mineral and organic materials.

Embodiments of the disclosed subject matter can be understood to have “dry” components, which may include the aforementioned media. In one or more embodiments of the disclosed subject matter, dry components, which as noted above may include any media used at the bottom of the containment device, may not exceed at or approximately 2 inches in thickness and/or may not exceed at or approximately 10 psf in dry weight. For example, the dry components, including the media, may have a thickness that is less than approximately ½ inch and/or may weigh approximately 4 psf dry or 1 psf dry. As yet another example, embodiments of the disclosed subject matter can have dry components that can have a thickness of at or approximately 1 inch. The media alone may be considered the system dry component(s). Optionally, the vegetation can also be considered part of the dry components in one or more embodiments of the disclosed subject matter. Alternatively, the media and roofing membrane may be considered the system dry components. Alternatively, the media, the roofing membrane, and the vegetation may be considered the system dry components.

In operation, the vegetated roof system, via the water catchment device or housing, may collect water. Collection sources can be from the sky, directly or indirectly, or via artificial means. For example, collection sources can include graywater sources, rainwater from the sky, rainwater captured in a tank and supplied to the vegetated system, and condensate from a condensate apparatus or system.

The collected water is held gravitationally, and allowed to pond above some or all of the vegetation of the vegetated surface up to a predetermined maximum depth as defined by the geometry of the catchment device. The water can escape the system based on the height of the water and the vegetation configuration, as well based on environmental factors such as those mentioned above, through evaporation, evapotranspiration, or transpiration. That is, water can escape the system initially via only evaporation, for example, when the water level is entirely above the vegetation. Then, when the water level is reduced to expose the vegetation, water can escape the system via evaporation and transpiration. Once the water level drops such that the only remaining water is in the media or the vegetation, water can escape the system via only transpiration.

In one or more embodiments of the disclosed subject matter, the system may be allowed to dry or desiccate completely or substantially completely between water receipt events such as rainfall. Such periodic drying out or desiccation can allow the system to have a maximum ambient recharge capacity, for example, an ambient recharge capacity of 60% of storage capacity, 75% of storage capacity, 81% of storage capacity, of 90% of storage capacity, of 95% of storage capacity, of 98% of storage capacity, of at or about 60% to at or about 98%, or of at or about 75% to at or about 98%. Further, optionally, the system can be allowed to dry or desiccate completely or substantially completely, for example, to at or about 3% of its water capacity, without the need for supplemental irrigation. Alternatively, supplemental irrigation can be implemented. Supplemental irrigation sources can be, generally speaking, from a non-municipal source, such as a well, a lake, or from harvested rainwater.

Turning back to FIGS. 7A-7B, these figures, generally speaking, expressly show an embodiment of the disclosed subject matter that implements water detention via a valved drain in the water catchment device or housing. Though only one valved drain is illustrated, a plurality of valved drains may be implemented, for example, one or more in each side wall, one or more in the first end wall, and/or one or more in the bottom surface or wall. FIGS. 8A-8B do not illustrate a valved drain and thus may be representative that the water catchment device or housing is for water retention only and not detention. Of course, the mere omission or inclusion of the valved drain does not necessarily limit the embodiments illustrated in FIGS. 7A-7B and 8A-8B, as such embodiments or variations thereof can be for water retention, detention (passive and/or active), and/or retention and detention.

Discussing now detention, detention may be implemented to increase or expedite ambient recharge capacity, whereby evaporation and evapotranspiration are supplemented by controlled release of water as another means by which water can leave or escape the system. Thus, the system or device may be rendered both a stormwater retention and detention device or system. Incorporation of detention can allow the system to lessen the intensity of stormwater runoff (delay peak flow), for example, even if weather events exceed the capacity of the system to retain additional volumes.

Detention (i.e., the controlled release of water) can be active or passive. For example, controlled on/off and/or variable water release (i.e., active detention) may be implemented by use of one or more valves that drain the catchment volume (such as illustrated diagrammatically in FIGS. 7A-7B). Each valve may be electronically controlled using circuitry (e.g., a computer, an electronic timer, a sensor, etc. or combination thereof). Thus, in order to dry the catchment device or system more quickly than evaporation and evapotranspiration alone, one or more valves may be opened to allow water to flow from the catchment system. Further, the one or more valves could be opened at or near the end of a given drying time, or opened and closed in order to slowly allow water to drain, or opened or closed seasonally. Optionally, the one or more valves can be opened as a result of remote system monitoring, utilizing devices such as moisture sensors and a weather station. Remote monitoring may alert a human to manually open a valve, or monitoring could trigger a computer program remotely to open or close valves. Of course, passive detention can optionally or alternatively be implemented, as discussed below.

Other examples of controlled release of water include release through engineering the catchment device to provide a relatively slow release of water via one or more drain holes, one or more scuppers, one or more spigots, one or more perforations, semi-permeable membranes, or use of membranes or fabrics with an engineered permissivity. Such controlled release can be considered passive detention. As for a more specific example, in one or more embodiments that incorporate or that can incorporate detention, the catchment device or housing may be lined with a semi-permeable geosynthetic membrane that can allow water to percolate out of the catchment devices at a given rate. Suitable materials for the membrane may include a capillary fabric, a bentonite clay liner, industrial felt, non-woven geotextiles of polypropylene or rayon or polyester, etc. Alternately, the semi-permeable membrane may be a perforated waterproof material.

Utilization or incorporation of water detention in or with one or more embodiments of the disclosed subject matter may be desired or advantageous if evaporative and evapotranspirative losses are calculated to require more time than the time between rain events, or more time than is required to prevent mosquito breeding. For example, if a catchment device retains 1 gallon of water, and combined evaporative and evapotranspirative losses are calculated to be 0.02 gallons/hr, the system can require approximately 50 hours to dry. If drying conditions exist for 10 hours per day, the system can require approximately 5 days to dry via evaporation and evapotranspiration alone. If the required drying time is 3 days, then the system can be configured to allow 0.4 of the 1.0 gallons to drain out of the system over a 3-day (72 hour) period, or at a rate of 0.006 gallons/hr, for example. The area of permissivity may be limited to a specific portion of the catchment device, such as the side bordering the deep end. If the permeable area is 3 inches by 4.8 inches (0.1/sf), for example, and it is desirable or intended to allow a controlled release of 0.006 gallons/hour, the membrane can require a permissivity rate of approximately 0.06 gallons/hr/sf, for instance.

Of course, though not expressly illustrated in figures other than FIGS. 7A-7B, detention features may be implemented in or with other described or illustrated embodiments, such as those described and illustrated with figures other than FIGS. 7A-7B. Alternatively, embodiments of the disclosed subject matter, such as those described and illustrated with figures other than FIGS. 7A-7B, may not be operative or functional to provide water detention operations.

As noted above, embodiments of the disclosed subject matter are not limited to implantation in or with roofs or roof systems. However, in terms of roofs, non-limiting examples include light-weight clear-span structures, flat or angled roofs (e.g., standing seam roofs), etc. In one or more embodiments, the water containment devices or housings can be aligned with a roof structure such that areas of maximum water volume and/or weight are aligned with roof areas having greater structural capacity, such as under a vertical beam. Further, the vegetated system according to embodiments of the disclosed subject matter may be attached, fixedly or removably, to the roof or roof system via any suitable attachment means, such as via purlins or other anchor points atop the roof. As will be discussed in more detail below, optionally, an air layer may be provided between the water containment devices or housings and the portion of the roof structure on, over or to which the water containment devices or housings are arranged.

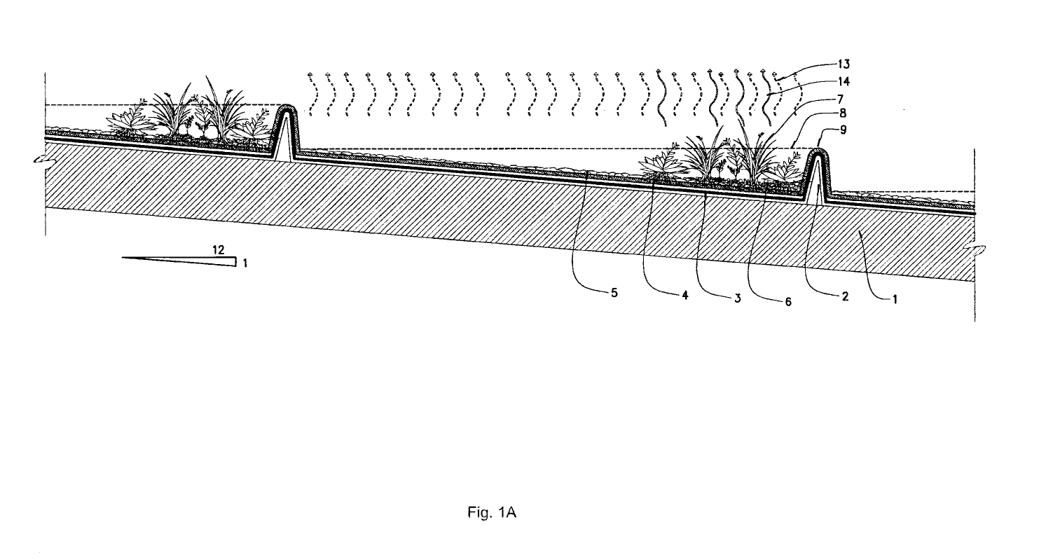

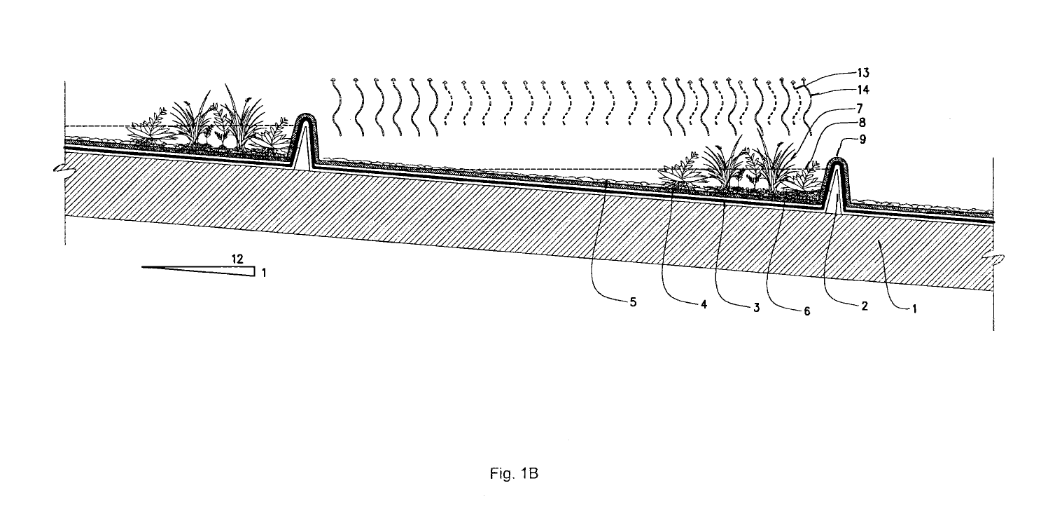

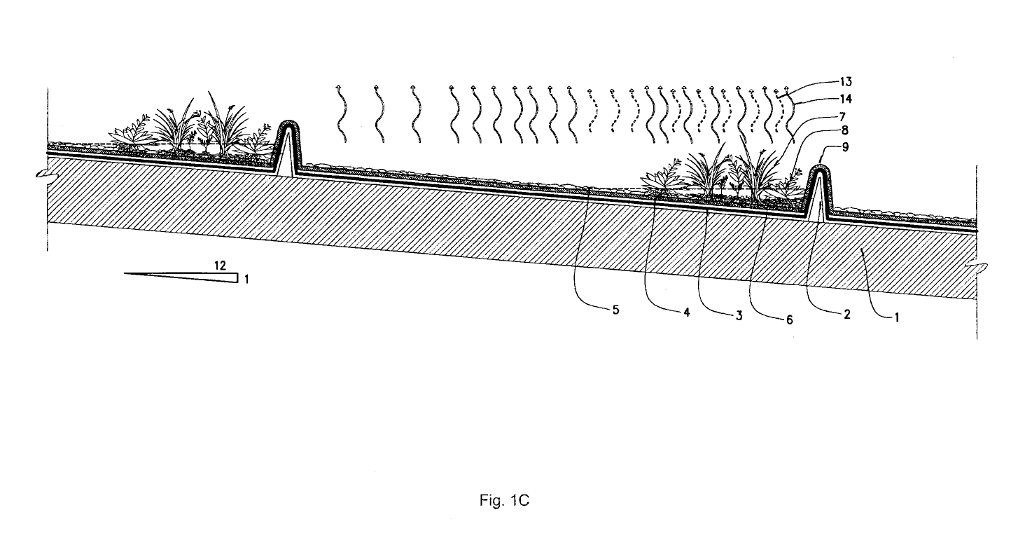

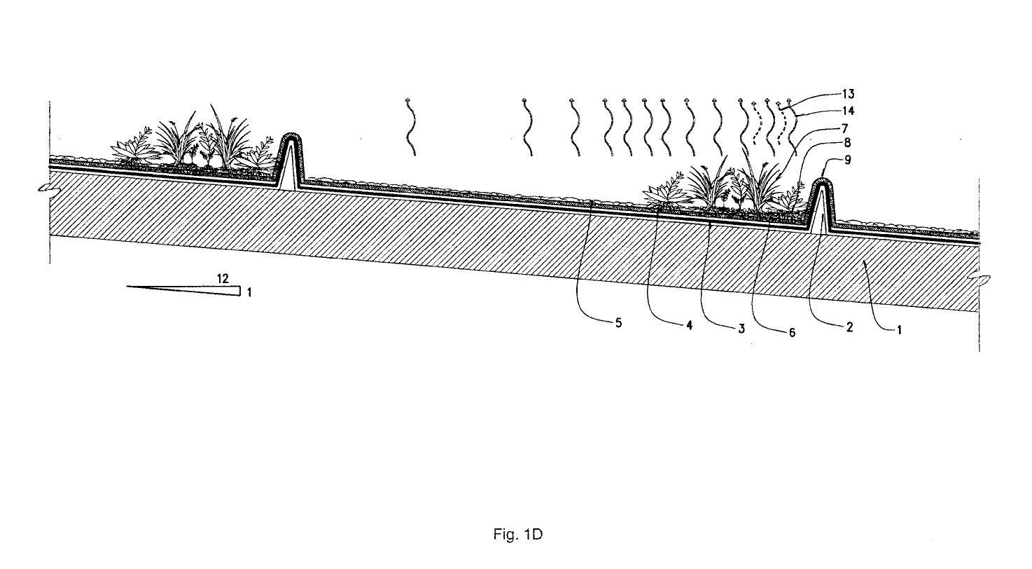

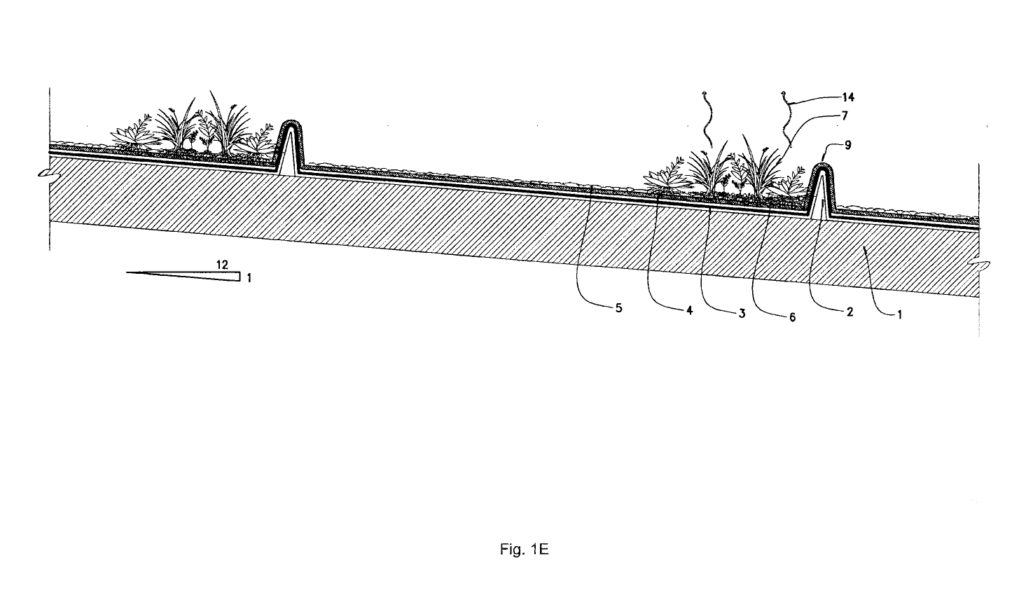

Turning now to FIGS. 1A-1E, 2A-2E, 3A-3E, 4A-4E, 5A-5E, and 6A-6E, these figures show a portion of a vegetated roof system according to various, non-limiting embodiments of the disclosed subject matter, including examples of vegetation that may form a part of the system. FIGS. 1A-1E, 2A-2E, 3A-3E, 4A-4E, 5A-5E, and 6A-6E also show example representations of sequences of gravitational water escaping the system over time. Incidentally, FIGS. 1A-1E, 2A-2E, 3A-3E, 4A-4E, 5A-5E, and 6A-6E show the ratio 12 length to 1 maximum height, but embodiments of the disclosed subject matter are not limited to these dimensions or this ratio. For example, a ratio of 12 or 36 length and 2 maximum height may be employed.

Each roofing structure of FIGS. 1A-1E, 2A-2E, 3A-3E, 4A-4E, 5A-5E, and 6A-6E is illustrated as a portion of a slanted roof, such as a slanted standing seam roof. As will be discussed in more detail below, the roofing structure can include or can be fitted (including retrofit) with vegetated systems according to embodiments of the disclosed subject matter.

The embodiment of FIGS. 1A-1E will be discussed first. As illustrated in FIGS. 1A-1E, the bottom surface 3 of the catchment device (which in this embodiment is combined with a waterproof membrane) can be formed on a deck or roof portion 1 which has a plurality of weirs 2. The weirs 2, and anything thereon, can define a containment edge of the water containment device. Sidewalls of the deck or roof portion 1 (not expressly shown) can define other containment edges. Further, the weirs 2 can divide plural, individual water containment devices or housings and may allow water conveyance once a maximum volume is achieved in a particular water holding cavity or housing. In certain instances, such water conveyance from one containment device to another can constitute a water source of the receiving containment device. Further regarding FIGS. 1A-1E, the weirs 2 are below the water proof membrane 3, as is the capillary fabric 4.

As can be seen from FIGS. 1A-1E, the water catchment device or housing is arranged such that its bottom surface 3 slopes to one side, forming a deep end with a water holding depth and a shallower end on the opposite side of the deep end. For example, the deep end may hold four inches of water and the shallow end may hold ½ inch of water or less. Optionally, the maximum height of water at the deep end may be no more than at or about ½ inch to at or about 4 inches.

The vegetated system can have a media layer in the form of a capillary material 4. Such capillary material 4 can continuously or discontinuously line the bottom surface 3 and can have a thickness of ¼ inch, for instance. The capillary material can wick water, for instance laterally or “uphill” from areas of greater moisture to areas of lower moisture. For example, when gravitational water submerges the deeper end but not the shallower end, the capillary material can wick water from the deeper end to the shallower end, which can allow vegetation at the shallower end to transpirate after gravitational water has left that area.

Vegetation in the form of moss 5, for example, can anchor directly to the capillary material 4 and can substantially cover the surface of the capillary material 4, particularly at the shallower end. At the deeper end of the catchment device, a discontinuous layer of porous aggregate(s) 6 can be placed, for example, not to exceed ½ inch in thickness. The deeper end may be covered with a combination of vascular or non-vascular plants such as moss, quillwort and succulents.

FIG. 1A illustrates a situation when the vegetated system is filled to maximum water height level defined by the geometry of the water catchment device or housing. Notably, the surface area of the device is substantially covered with gravitational water (represented by the horizontal dashed line 8). In this state, water can leave the system primarily through evaporation, and secondarily through transpiration of vascular plants whose leaves and stems extend above the water elevation. Optionally, no stems or leaves may extend above the maximum water level, in which case water would only leave through evaporation.

FIGS. 1A-1E illustrate that as water evapotranspirates (i.e., evaporates and transpirates), the water level drops, exposing portions of the shallow end to the atmosphere. As this vegetation portion becomes exposed to the atmosphere, transpiration can begins in this vegetation portion, which can accelerate water discharge or escape from the system.

As more water evapotranspirates, the water level drops further, exposing more plants to the atmosphere, and further accelerating evapotranspiration. Gravitational water may only remain in the deeper end of the catchment device; however the capillary fabric 4 can wick water from the deep end of the water containment device to the shallow end of the water containment device, which can allow vegetation at the shallow end of the device to continue transpiration after water has left the area of the water catchment device, further accelerating water loss or escape and increasing ambient recharge capacity. Thus, as water levels drop, the vegetation can remain hydrated until the full system approaches desiccation.

Once water has substantially left the system, evaporation ceases and transpiration substantially ceases. At this point the vegetated system may be considered to have returned to a state of maximum ambient recharge capacity. For example, the vegetation may dry out to at or approximately 3% of its water capacity, to at or about 2% of its water capacity, or to at or about 1% or less than 1% of its water capacity.

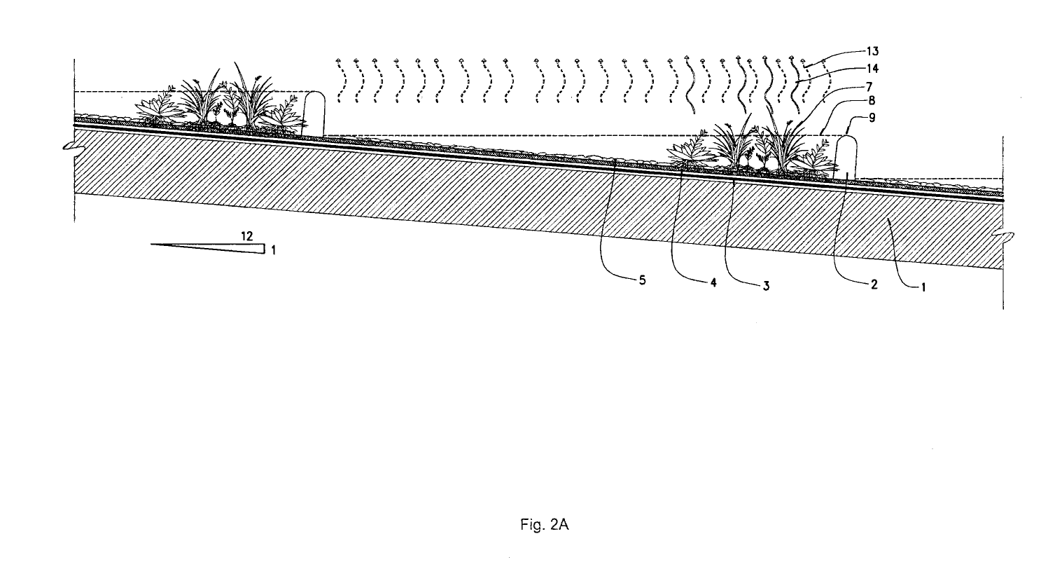

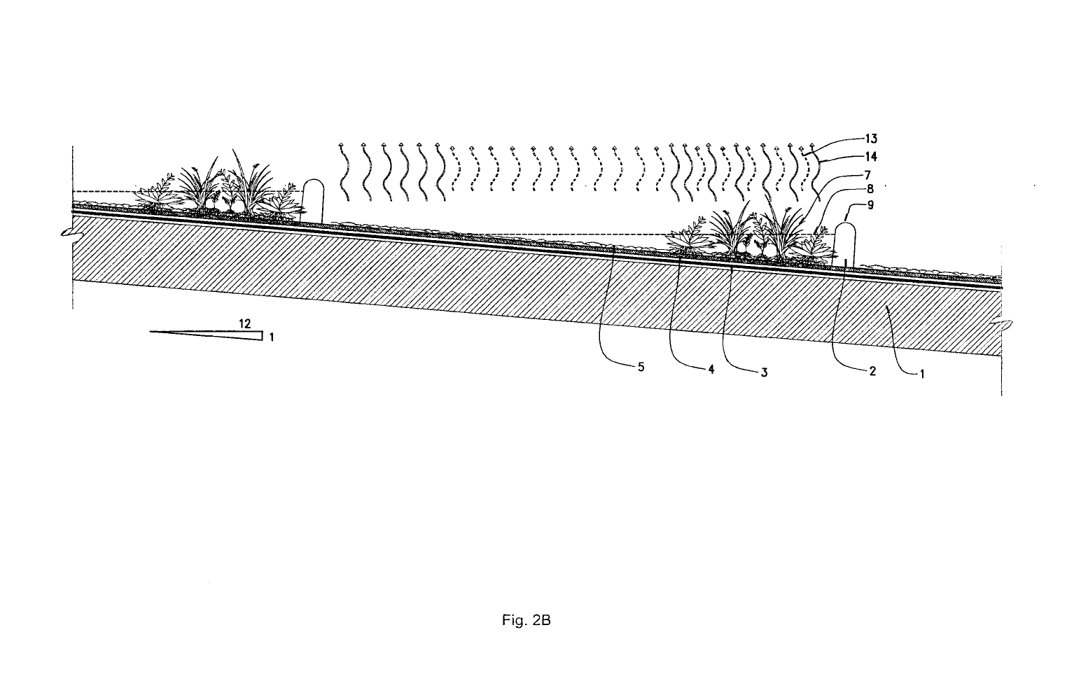

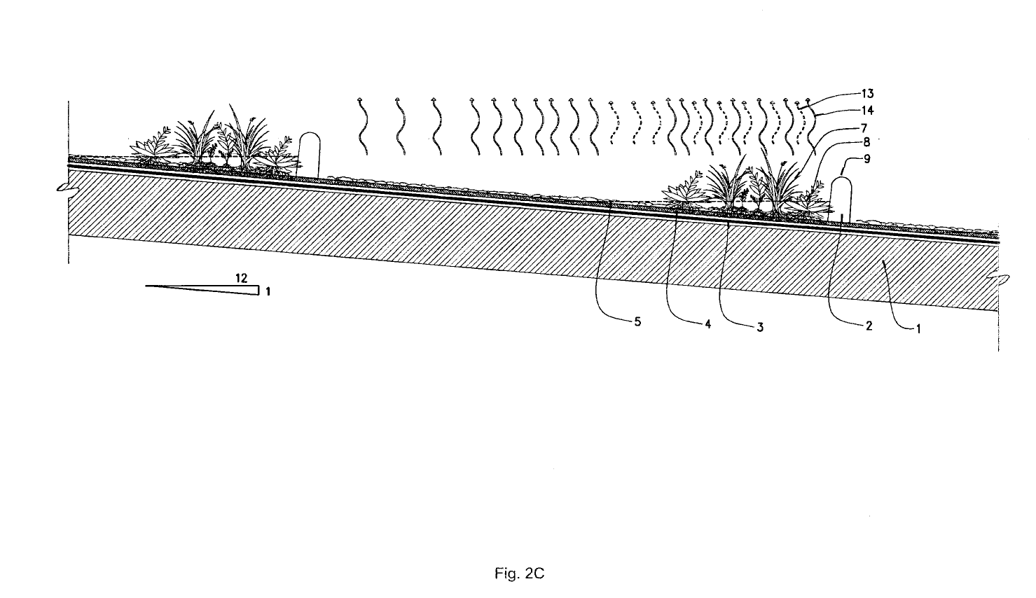

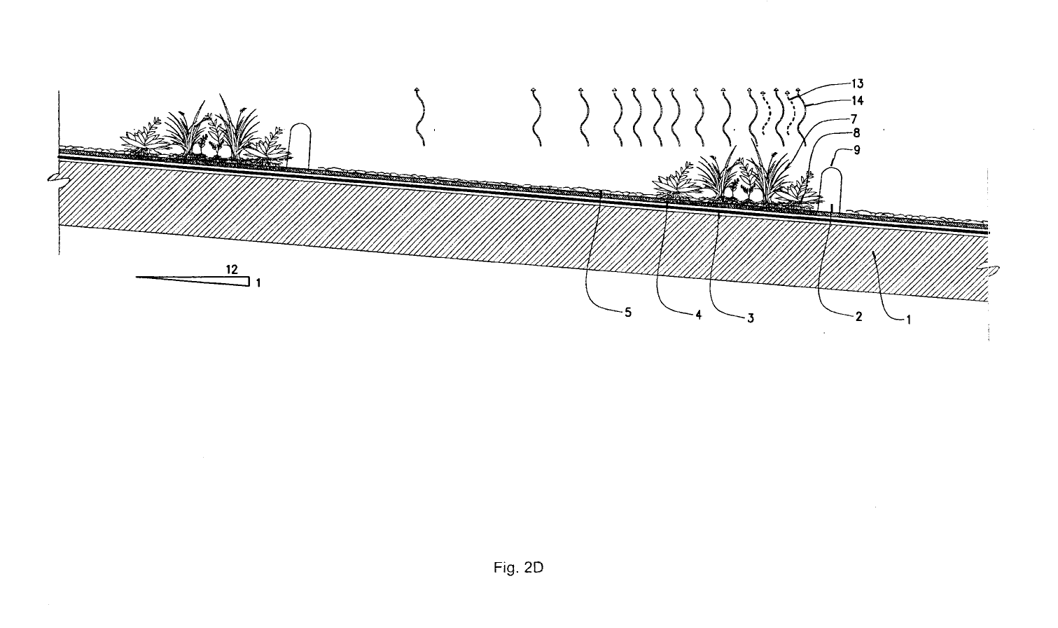

FIGS. 2A-2E, 3A-3E, 4A-4E, 5A-5E, and 6A-6E illustrate alternative, non-limiting embodiments of the disclosed subject matter.

In FIGS. 2A-2E, the weirs 2 are different shape and are above the waterproof membrane 3. Additionally, this embodiment does not include aggregate(s) 6 (though optionally it could). Further, capillary layer 4 is under the weirs 2, which can prevent or reduce wind uplift and/or assist with percolation.

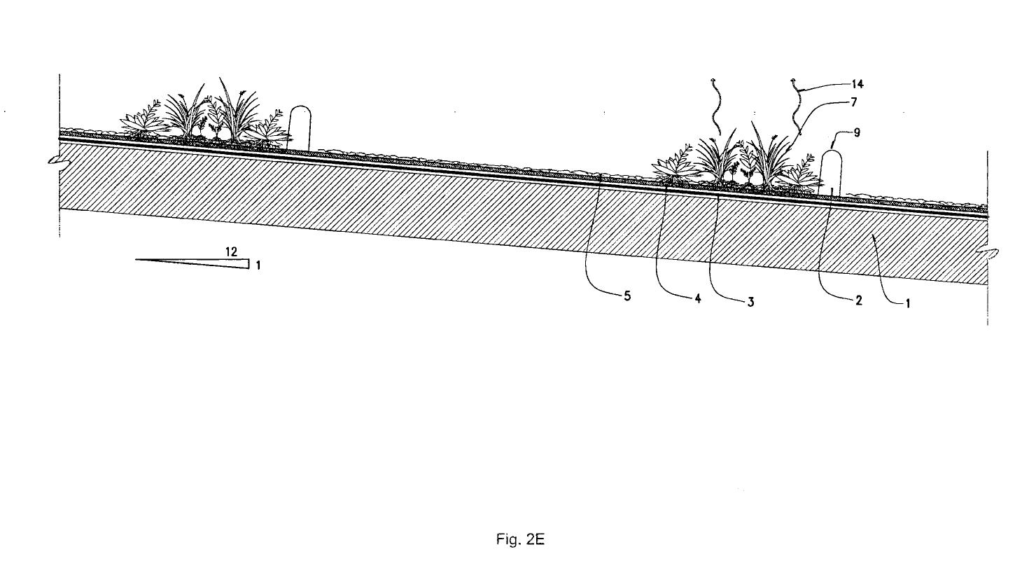

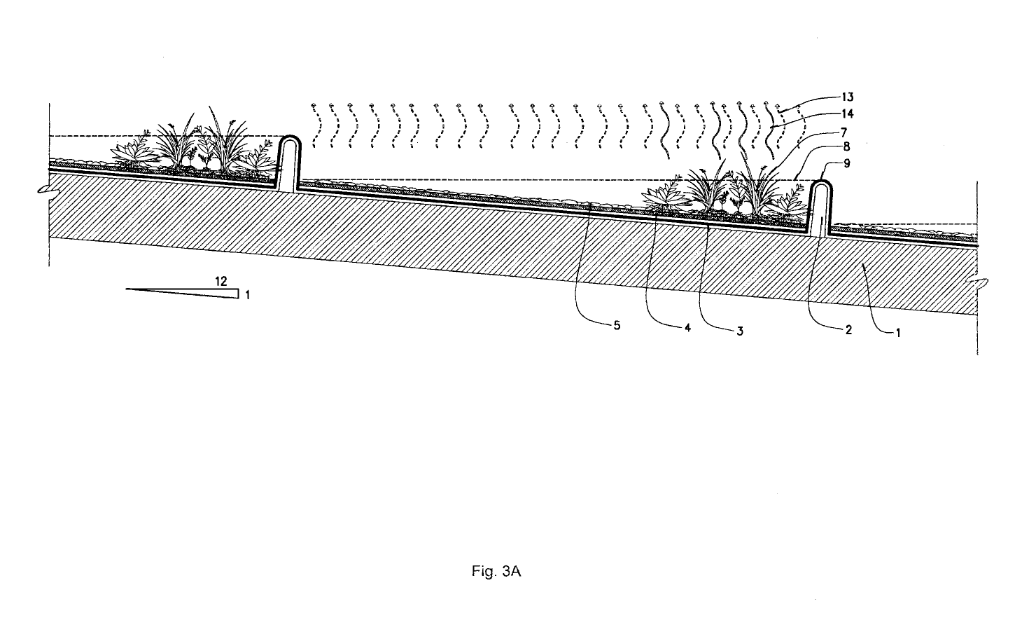

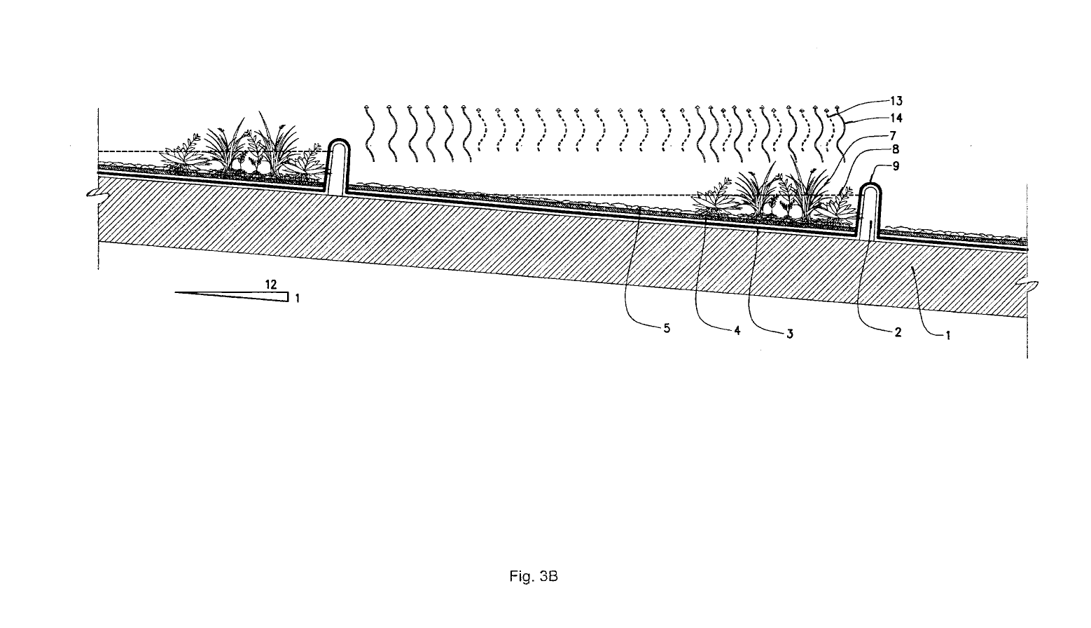

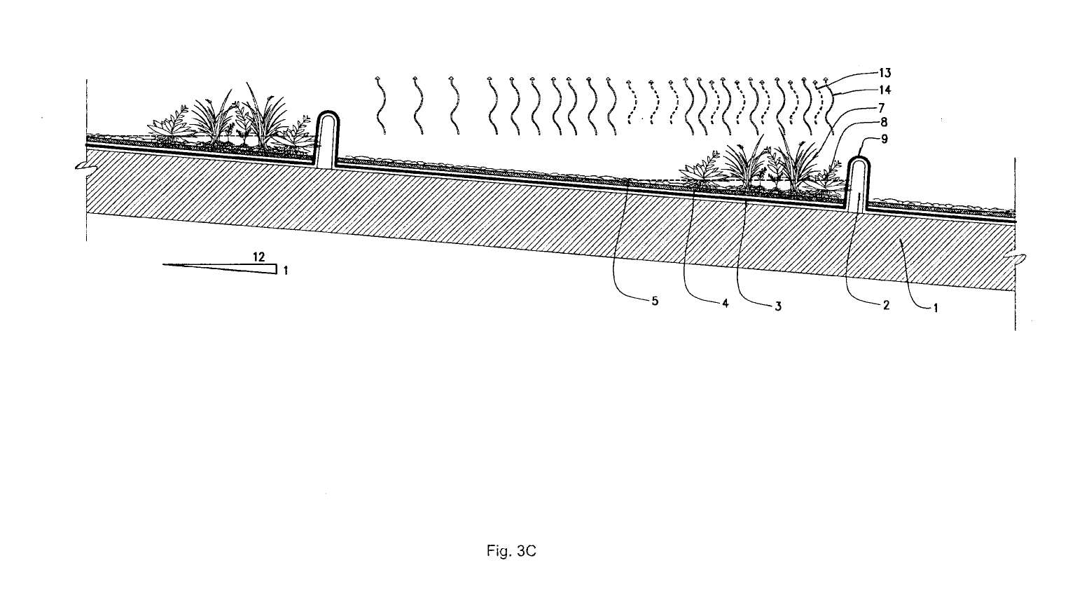

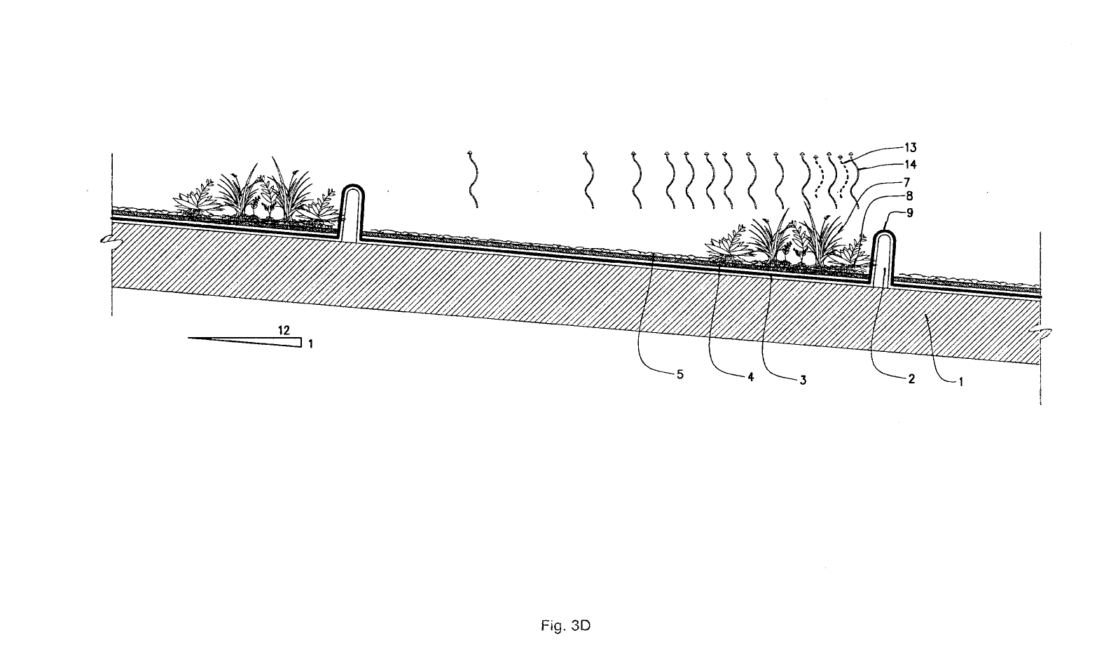

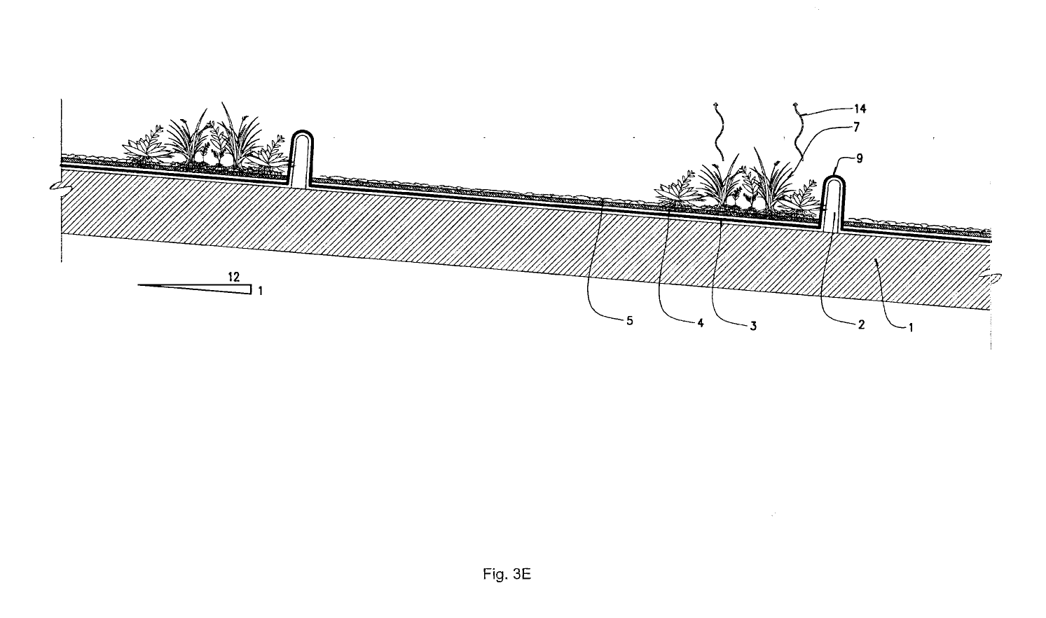

In FIGS. 3A-3E, the capillary layer 4 is above the weirs 2. Additionally, like FIGS. 2A-2E, the embodiment of FIGS. 3A-3E does not include aggregate(s) 6 (though optionally it could).

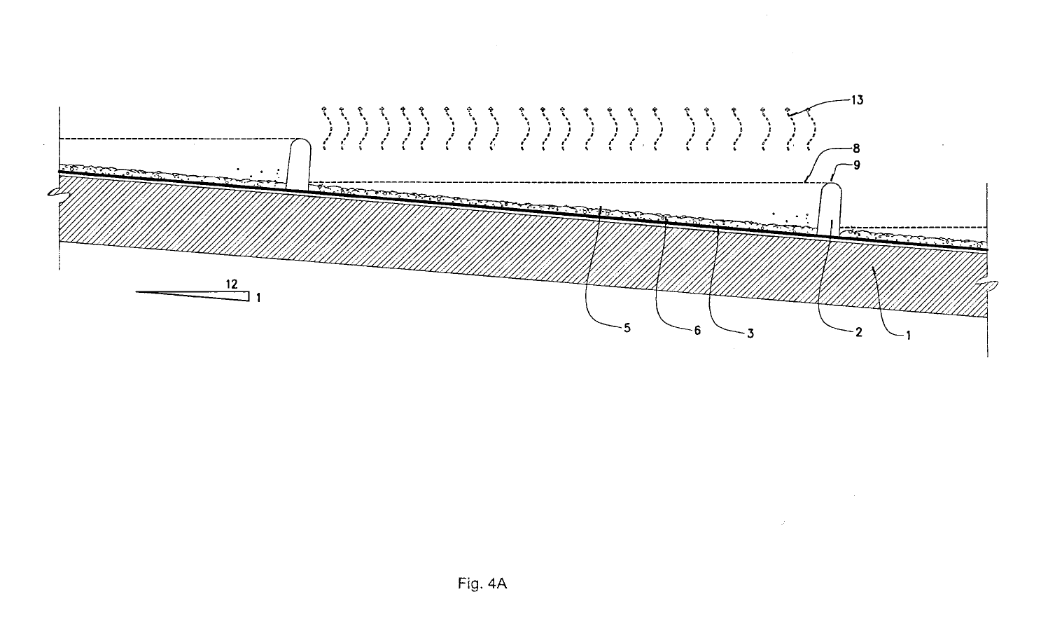

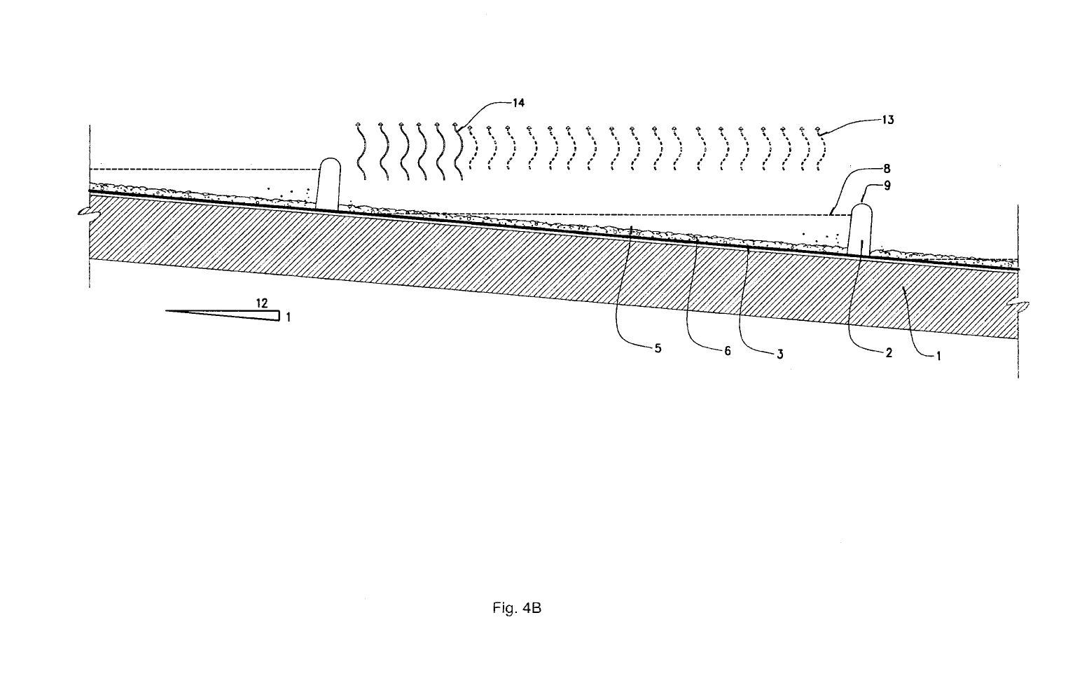

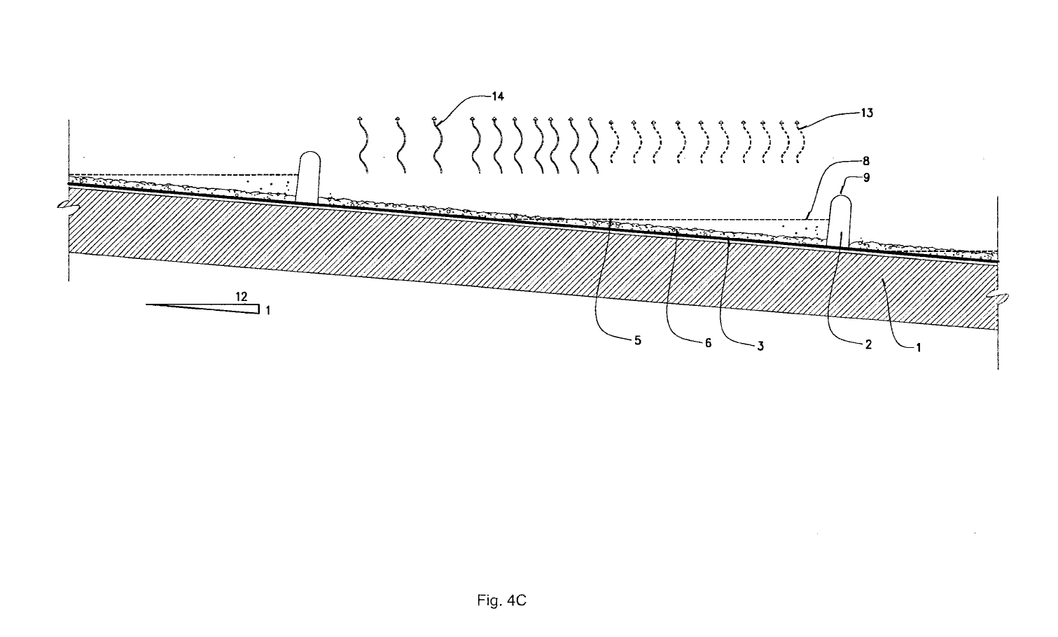

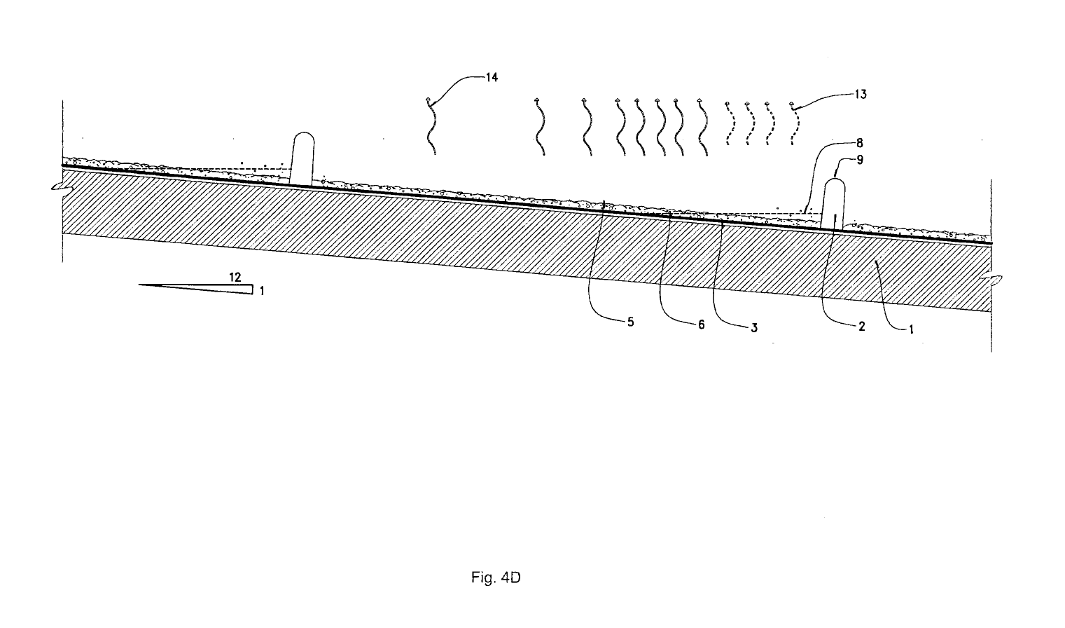

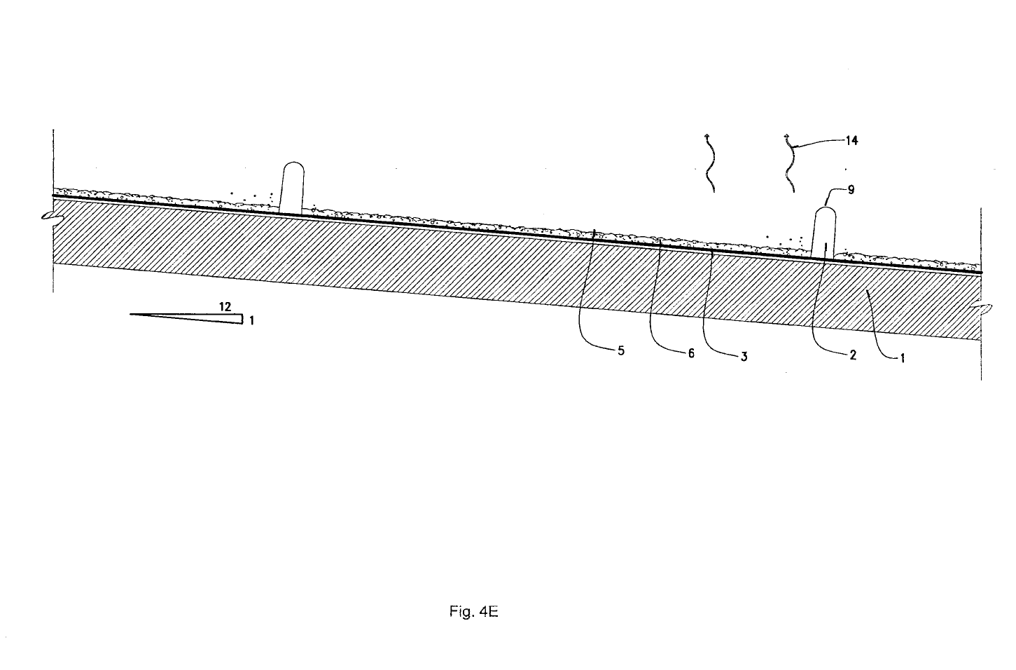

In the embodiment of FIGS. 4A-4E, the weirs 2 are above the waterproof membrane 3. Further, this embodiment does not include a capillary layer 4, but does include aggregate(s) 6. Additionally, vascular plants are not used. Rather, only non-vascular plants, such as moss are used.

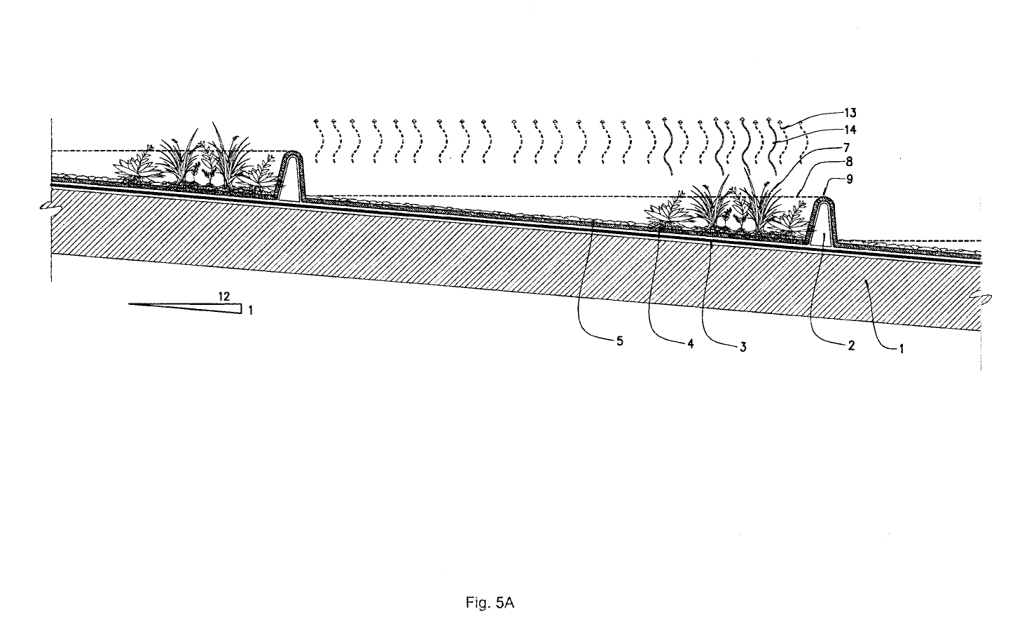

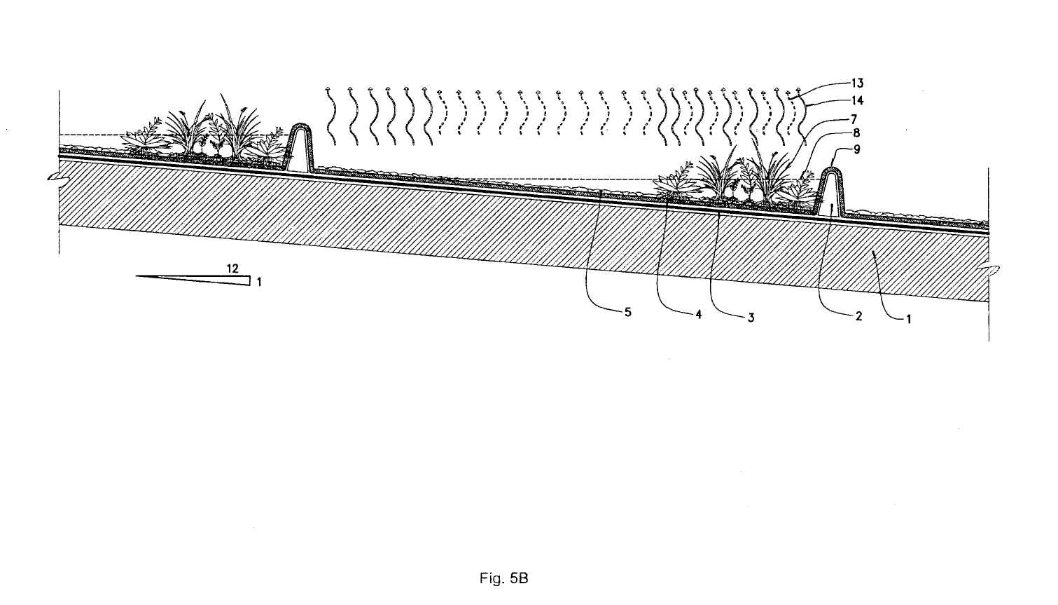

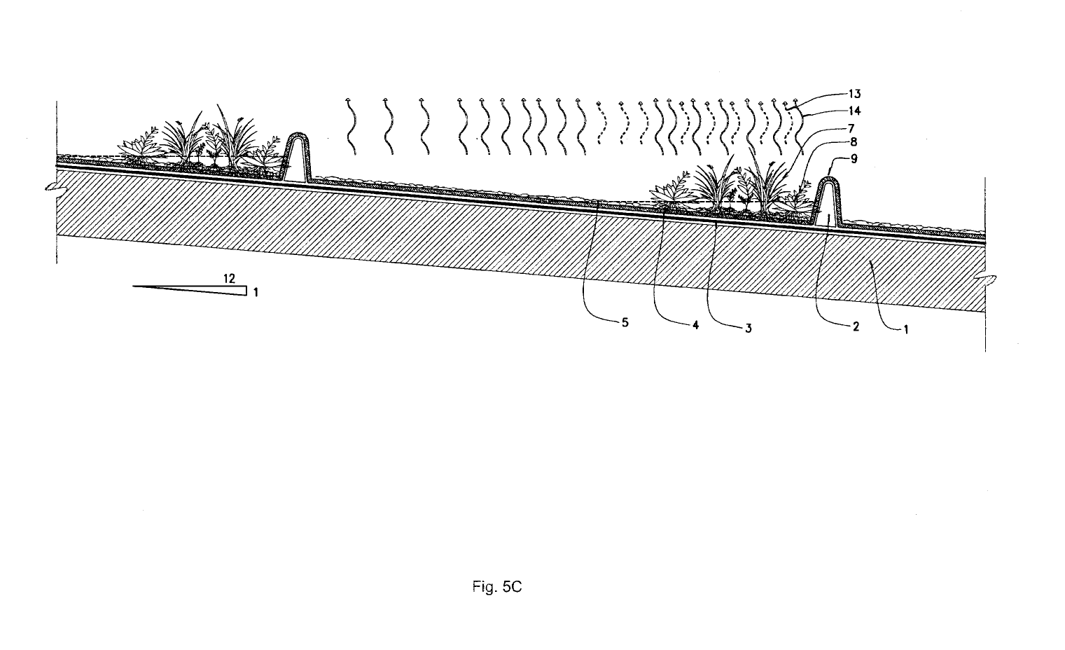

In the embodiment of FIGS. 5A-5E, the capillary layer 4 is above the weirs 2, but the waterproof later 3 is below the weirs 2. Additionally, this embodiment does not use aggregate(s) 6 (though optionally it could).

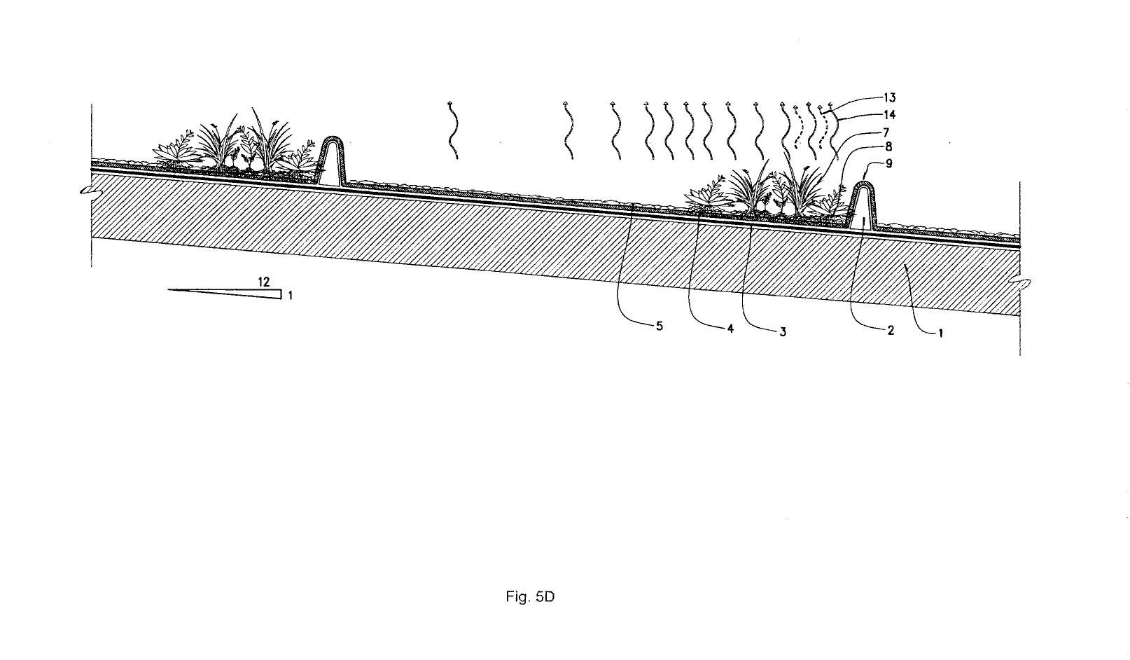

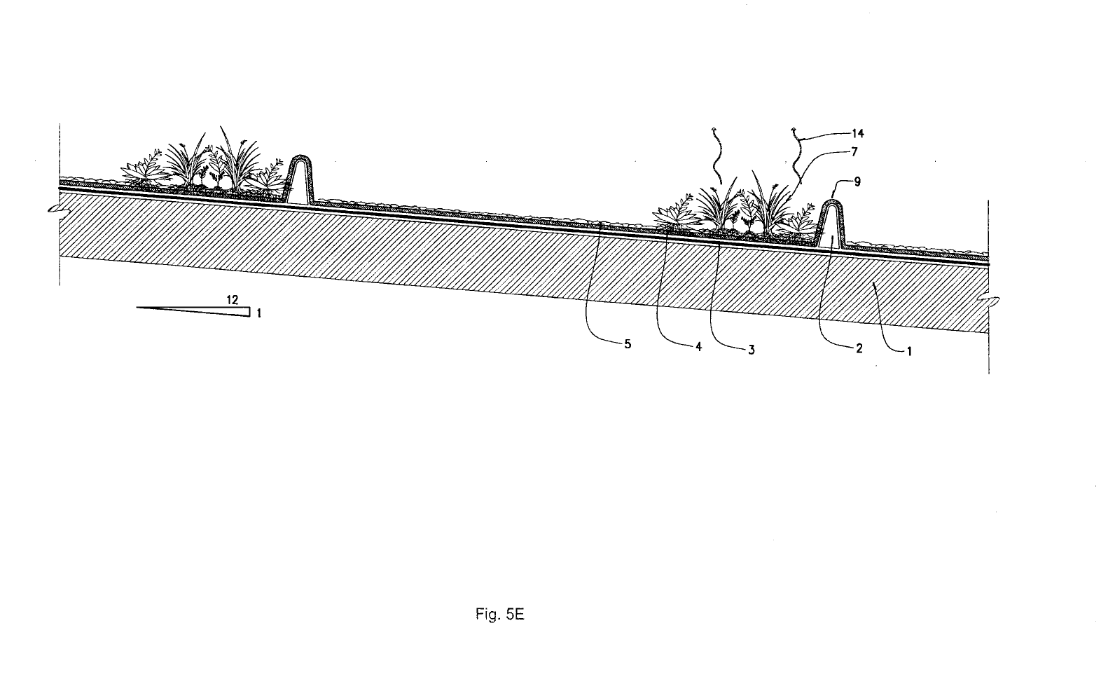

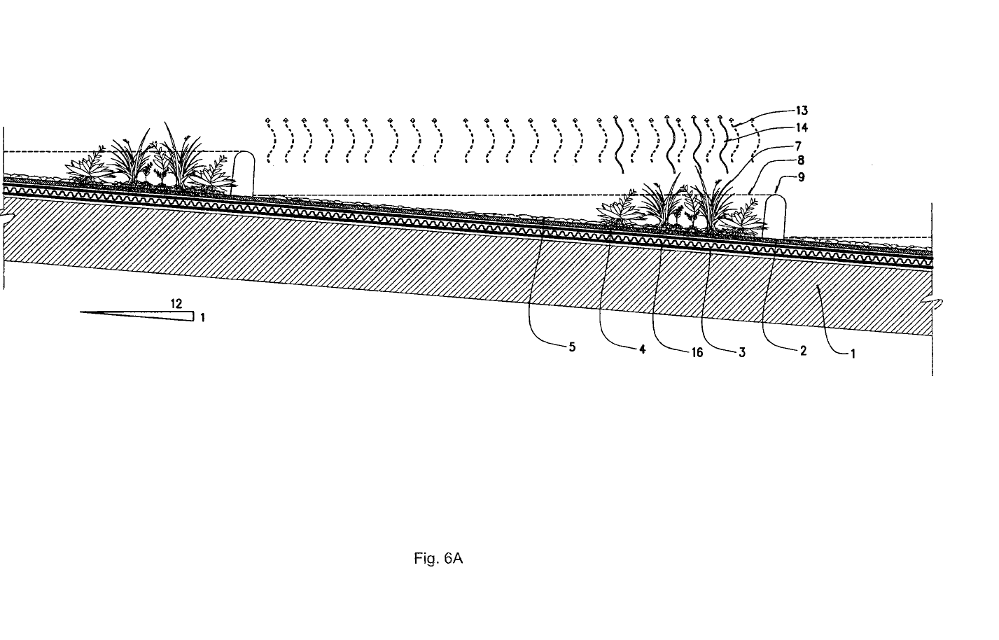

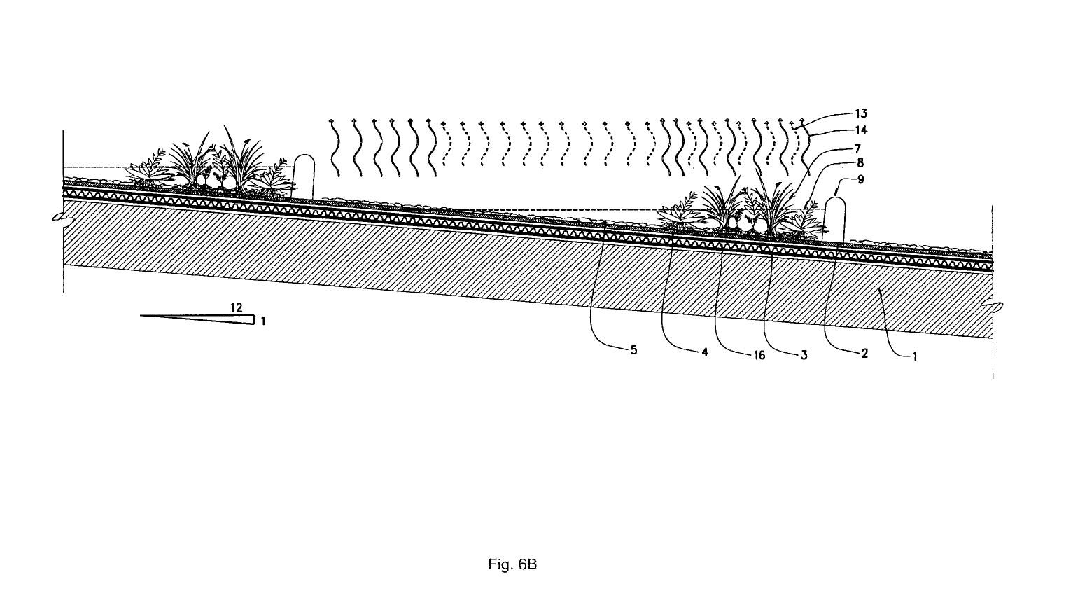

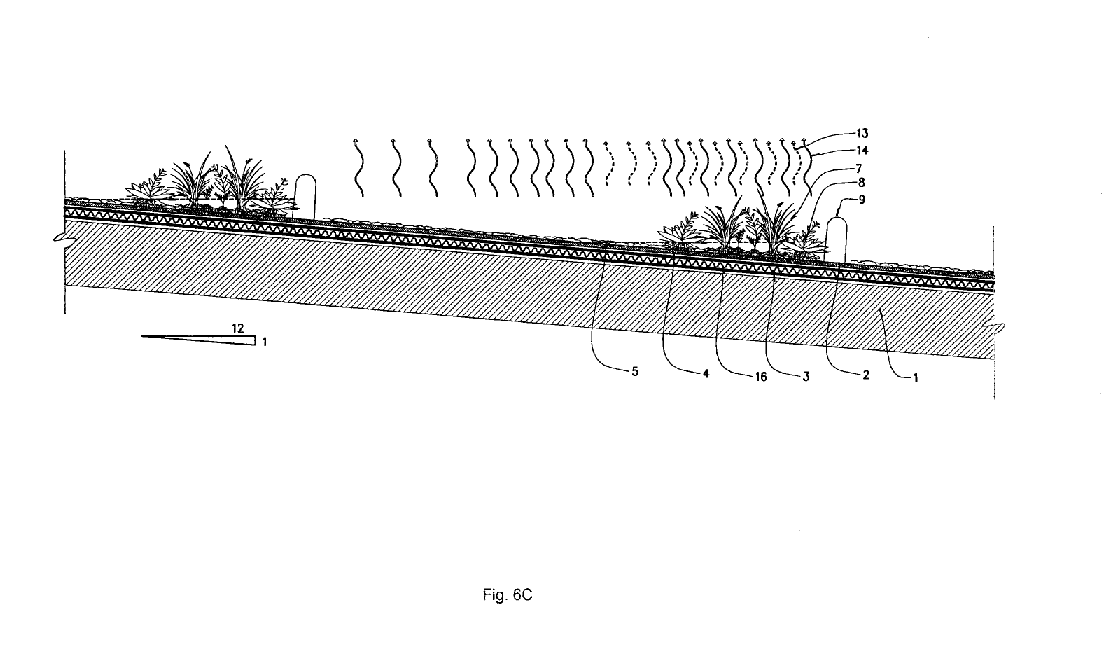

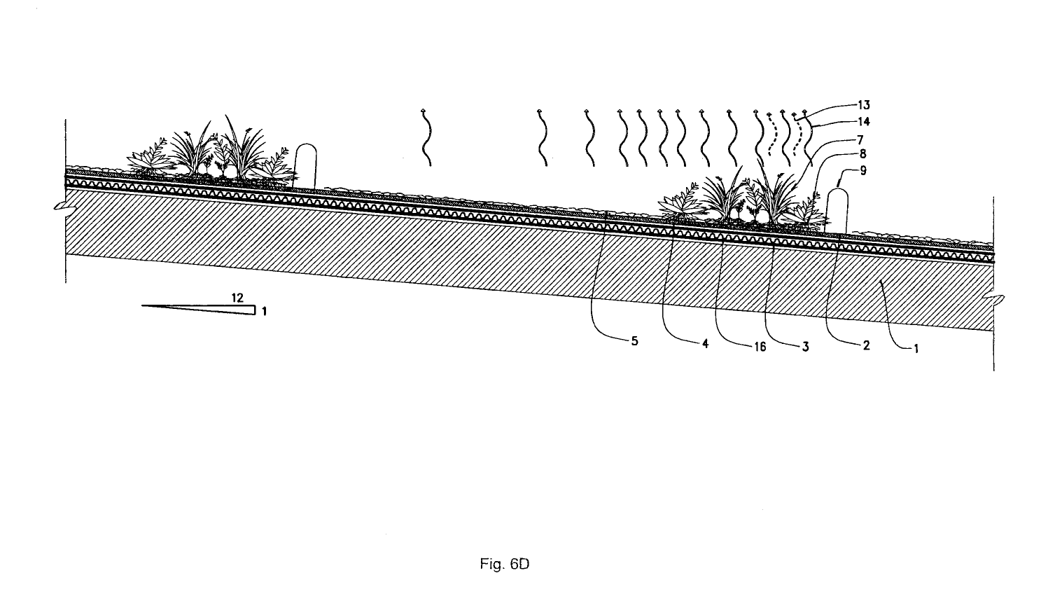

The embodiment of FIGS. 6A-6E is similar to the embodiment of FIGS. 2A-2E, but shows an air layer 16. The air layer 16 can be between the capillary layer 4 and the waterproof membrane 3, for instance. Though FIGS. 6A-6E illustrate the air layer as being continuous, the air layer 16 may be comprised of a plurality of individual air layer portions 16, for instance, separated by a portion of the roof structure, a portion of the water catchment device or housing, and/or by some other structure, such as a grating, elevated or flat, or a wire mesh. Thus, the low permeability or impervious membrane (e.g., capillary layer 4) and everything above can be elevated above and off the bottom of the roof, separated by the air gap 16. Though not expressly illustrated with other embodiments, an air layer 16 (including a continuous air layer or individual, separate air layer portions) can be implemented.

Though FIGS. 1A-1E, 2A-2E, 3A-3E, 4A-4E, 5A-5E, and 6A-6E illustrate the various components and component combinations implemented with a volumetric triangular prism, such components and component combinations can be implemented with or in the other geometric cavity or housing geometries disclosed and claimed herein.

Embodiments of the disclosed subject matter can thus have a relatively high volumetric water storage (e.g., up to approximately 90% of volume) and high ambient recharge capacity (e.g., up to approximately 95% of storage capacity) within a vegetative system. Non-limiting examples are provided below.

In an embodiment having a maximum ponding depth of 4.00 inches, the absorbent media can be ¼ inch thick within the water containment device. The absorbent media may be a capillary fabric which absorbs at or approximately 66% of its volume in water, leaving 3.75 inches of storage above the media, which can retain over 95% of its volume in captured water.
3.75×95%=3.56
0.25×66%=0.17
3.56+0.17=3.73
3.73/4.00=93% of volume is water.

Mosses, for example, can continue to live on the capillary fabric if completely desiccated. If the system completely desiccates, the system can have a 98% of volume ambient recharge capacity, for instance.

In another example, in an embodiment having a ponding depth of 2 inches, the absorbent media can be ½ inch thick within the containment device. The absorbent media may be a granular media fabric which absorbs approximately 35% of its volume in water, leaving 3.50 inches of storage above the media, which retains over 95% of its volume in captured water.
1.50×95%=1.42
0.50×35%=0.18
1.42+0.18=1.61
1.61/2.00=80% of volume is water.

Vascular plants such as Sedum, cacti, Talinum, Diamorpha and quillwort can continue to live on the absorbent media if dried to approximately 3% of its water capacity, thereby yielding an 81% ambient recharge capacity, for instance.

According to one or more embodiments of the disclosed subject matter, vegetation can be pre-grown panels (e.g., pre-grown water containment devices or housings, which can be placed on or fixed to a roof structure). Moss, for example, can be propagated or allowed to propagate on a roof, for instance, directly or indirectly on a water containment device or housing according to embodiments of the disclosed subject matter. Vegetation other than moss can be propagated on the roof or pre-vegetated and established primarily from cuttings and seeds. Temporary irrigation may be required for the first season.

Pre-vegetated panels may be mechanically anchored to the roof or may be adhered to the roof. If vegetation is propagated directly on the waterproofing membrane, the vegetation may anchor directly to the membrane without the use of chemical adhesives or mechanical anchoring. Moss rhizoids, for instance, may attach directly to roofing materials; as the moss matures, the moss becomes host to vascular species that root in the moss.

Moss can increase in thickness and biomass as it matures. As moss is capable of holding over 80% of its volume in water, the system maximum water holding capacity typically will not diminish as the system matures. The accumulated biomass of moss may create a rooting media for taller vascular plants.

Resistance to wind uplift may be achieved via a variety of means. The dry weight of the system may not be sufficient to provide wind uplift through ballast, which typically requires approximately 10 to 13 lbs/sf of dry weight. Mechanical attachment may be used, in which the dry components can be adhered to the roofing membrane surface, or in which the dry components are bolted, screwed, or strapped to the roof Components may be implemented under certain roof components, such as weirs, to reduce or eliminate wind unlift.

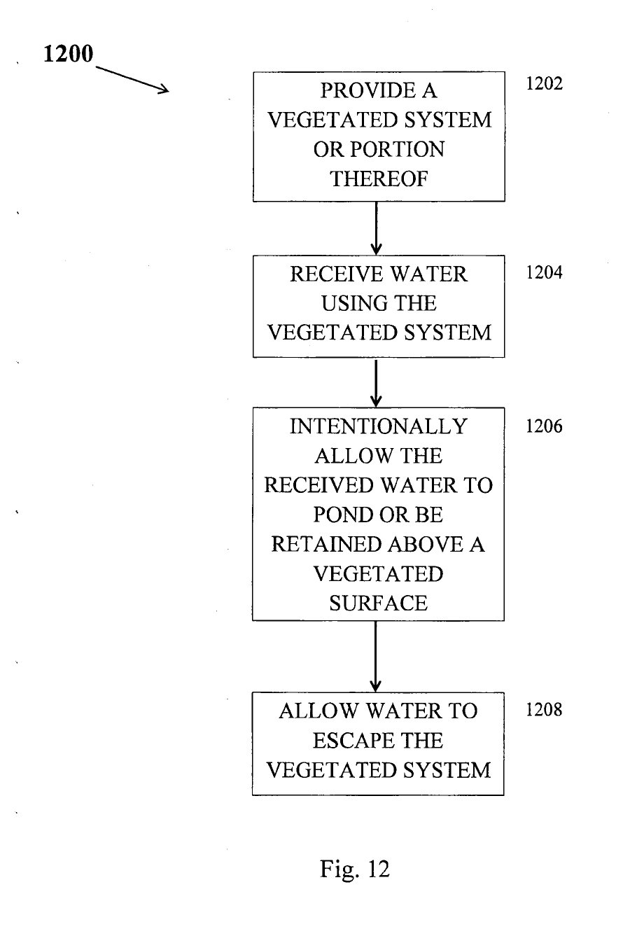

FIG. 12 is a block diagram of a method 1200 according to one or more embodiments of the disclosed subject matter.

The method can comprise providing a vegetated roof covering/covering structure/covering system or portion thereof as disclosed and/or claimed herein 1202. Optionally, the method can further comprise allowing receipt of water using the vegetated roof covering/covering structure/covering system as disclosed and/or claimed herein 1204; and allowing gravitational water to pond over the vegetated surface or layer as disclosed and/or claimed herein 1206. The method can further comprise allowing the water to escape, such as by evaporation, evapotranspiration, and/or detention, as disclosed and/or claimed herein 1208.

Embodiments of the disclosed subject matter can include:
(1) A vegetated roof covering having a structure and configuration to intentionally hold captured water gravitationally within and above a portion of a vegetated surface thereof.
(2) The vegetated roof covering according to (1), wherein the vegetated roof covering is configured to periodically desiccate, dry or dry out, substantially completely or partially.
(3) The vegetated roof covering according to (1) or (2), wherein the operation or function of the vegetated roof covering is not impaired by the periodic desiccation, drying, or drying out.
(4) The vegetated roof covering according to any one of (1) to (3), wherein vegetation of the vegetated roof covering survives the periodic desiccation, drying, or drying out and/or is healthy after the periodic desiccation, drying, or drying out.
(5) The vegetated roof covering according to any one of (1) to (4), wherein the vegetated roof covering is configured to retain or hold water and to allow the water to escape only via evaporation, only via evaporation and transpiration, or only via transpiration; only via evaporation, then only via evaporation and transpiration, and then only via transpiration; or only via evaporation and transpiration and then only via transpiration.
(6) The vegetated roof covering according to any one of (1) to (5), wherein the vegetated roof covering is configured to retain or hold water and to allow the water to escape only via evaporation, then only via evaporation and transpiration, and then only via transpiration.
(7) The vegetated roof covering according to any one of (1) to (6), wherein the vegetated roof covering is configured to retain or hold water and to allow the water to escape only via evaporation and transpiration and then only via transpiration.
(8) The vegetated roof covering according to any one of (1) to (7), wherein the vegetated roof covering is configured to retain or hold water and to allow the water to escape via either evaporation, evapotranspiration or transpiration, and via controlled release or active detention, the vegetated roof covering including a mechanism to perform the controlled release or active detention.
(9) The vegetated roof covering according to any one of (1) to (8), wherein the mechanism for controlled release or active detection includes at least one valve drain connecting the vegetated roof covering to a drainage system.
(10) The vegetated roof covering according to any one of (1) to (9), wherein the vegetated roof covering is configured to allow the water to escape via passive detention.
(11) The vegetated roof covering according to any one of (1) to (10), wherein the vegetated roof covering includes one or more passive detention means for performing passive detention of the water.
(12) The vegetated roof covering according to any one of (1) to (11), wherein the vegetated roof covering is configured to provide stormwater retention, stormwater detention, or stormwater retention and detention.
(13) The vegetated roof covering according to any one of (1) to (12), wherein the vegetated roof covering is configured to wick water from an area or portion thereof having gravitational water to an area or portion thereof without gravitational water.

(14) The vegetated roof covering according to any one of (1) to (13), wherein the vegetated roof covering includes one or more pieces or portions of capillary or hydrophyllic media or fabric configured to wick water from the area or portion of the vegetated roof covering having gravitational water to the area or portion of the vegetated roof covering without gravitational water.
(15) The vegetated roof covering according to any one of (1) to (14), wherein the vegetated roof covering is configured to store at least ½ inch of water, at least 1 inch of water, at least 1.5 inches of water, at least 2 inches of water, at least 2.5 inches of water, at least 3 inches of water, at least 3.5 inches of water, or at least 4 inches of water above the portion of the vegetated surface.
(16) The vegetated roof covering according to any one of (1) to (15), wherein the vegetated roof covering is configured to store no more than ½ inch of water, no more than 1 inch of water, no more than 1.5 inches of water, no more than 2 inches of water, no more than 2.5 inches of water, no more than 3 inches of water, no more than 3.5 inches of water, or no more than 4 inches of water above the portion of the vegetated surface.
(17) The vegetated roof covering according to any one of (1) to (16), wherein the vegetated roof covering is configured to store any amount from ½ inch to 4 inches of water above the portion of the vegetated surface.
(18) The vegetated roof covering according to any one of (1) to (17), wherein the portion of the vegetated surface excludes any vascular plants.
(19) The vegetated roof covering according to any one of (1) to (18), wherein the portion of the vegetated surface is the entire vegetated surface.
(20) The vegetated roof covering according to any one of (1) to (19), wherein the portion of the vegetated surface is less than the entire vegetated surface.
(21) The vegetated roof covering according to any one of (1) to (20), wherein the vegetated surface is defined as above an interface or juncture of an upper-most layer or part of a growing media for the vegetated surface and a shoot system, zone or maturation or stem or stems of the vegetation of the vegetated surface.
(22) The vegetated roof covering according to any one of (1) to (21), wherein the vegetated surface is defined as above an anchorage juncture of the vegetation of the vegetated surface and an upper-most layer or part of a growing media for the vegetated surface.
(23) The vegetated roof covering according to any one of (1) to (22), wherein vegetation of the vegetated surface is comprised of, is comprised essentially of consists of consists essentially of, or is selected from the group consisting of at least one of one or more types or varieties of moss, one or more types or varieties of lichen, and/or one or more types or varieties of non-vascular plants.
(24) The vegetated roof covering according to any one of (1) to (23), wherein vegetation of the vegetated surface is comprised of, is comprised essentially of, consists of, consists essentially of, or is selected from the group consisting of at least one of one or more types or varieties of moss, one or more types or varieties of lichen, one or more types or varieties of non-vascular plants, and/or one or more types or varieties of vascular plants.
(25) The vegetated roof covering according to any one of (1) to (24), wherein vegetation of the vegetated surface is comprised of, is comprised essentially of, consists of, consists essentially of or is selected from the group consisting of at least one of one or more types or varieties of moss, one or more types or varieties of lichens, one or more types or varieties of quillwort, Phacetia dubia, Sedum pusillum, Opuntia, Selanginella rupestris, Diamorpha Smallii or Elf Orpine, one or more types or varieties of bryophytes, one or more types or varieties of succulents, one or more types or varieties of cacti, one or more types or varieties of grasses, one or more types or varieties of sedges, and/or one or more types or varieties of wildflowers.
(26) The vegetated roof covering according to any one of (1) to (25), wherein the vegetated roof covering either is configured to be periodically irrigated using a lake or rainwater irrigation system or includes a lake or rainwater irrigation system to periodically provide irrigation water to irrigate the vegetation of the vegetated roof covering.
(27) The vegetated roof covering according to any one of (1) to (26), wherein the vegetated roof covering either is configured not to be artificially irrigated, does not include an artificial or supplemental irrigation system, or is not configured to operate or function with an artificial or supplemental irrigation system.
(28) The vegetated roof covering according to any one of (1) to (27), wherein the vegetated roof covering is configured to have or has an ambient recharge capacity of 60% of storage capacity, 75% of storage capacity, 81% of storage capacity, of 90% of storage capacity, of 95% of storage capacity, of 98% of storage capacity, of at or about 60% to at or about 98%, or of at or about 75% to at or about 98%.
(29) The vegetated roof covering according to any one of (1) to (28), wherein the vegetated roof covering is configured to have or has a volumetric water storage amount of up to 70% of volume, up to approximately 70% of volume, up to 80% of volume, up to approximately 80% of volume, up to 90% of volume, up to approximately 90% of volume, up to 93% of volume, up to approximately 93% of volume, up to 95% of volume, up to approximately 95% volume, at or about 70% of volume to at or about 95% of volume, or at or about 80% of volume to at or about 95% of volume.
(30) The vegetated roof covering according to any one of (1) to (29), wherein the vegetated roof covering includes an absorbent media having a thickness of at or about ¼ inch, at or about ½ inch, at or about ¾ inch, at or about 1 inch, at or about 1.25 inch, at or about 1.5 inch, at or about 1.75 inch, or at our about 2 inches or any amount from at or about ¼ inch to at or about 2 inches.
(31) The vegetated roof covering according to any one of (1) to (30), wherein the absorbent media has a dry weight that is at or about 10 psf or less, at or about 4 psf or less, any amount from at or about 4 psf to at or about 10 psf, or any amount from at or about 1 psf to at or about 10 psf.
(32) The vegetated roof covering according to any one of (1) to (31), wherein the vegetated roof covering includes one or more dry components, the one or more dry components, as a whole, having a thickness of at or about ¼ inch, at or about ½ inch, at or about ¾ inch, at or about 1 inch, at or about 1.25 inch, at or about 1.5 inch, at or about 1.75 inch, or at our about 2 inches or any amount from at or about ¼ inch to at or about 2 inches.
(33) The vegetated roof covering according to any one of (1) to (32), wherein the one or more dry components, as a whole, having a dry weight that is at or about 10 psf or less, at or about 4 psf or less, any amount from at or about 4 psf to at or about 10 psf, or any amount from at or about 1 psf to at or about 10 psf.
(34) The vegetated roof covering according to any one of (1) to (33), wherein the captured water is rainwater or stormwater captured directly.
(35) The vegetated roof covering according to any one of (1) to (34), wherein the structure of the vegetated roof covering has a first area with a first depth and second area with a second depth different from the first depth.
(36) The vegetated roof covering according to any one of (1) to (35), wherein the structure of the vegetated roof covering has a uniform depth.
(37) The vegetated roof covering according to any one of (1) to (36), wherein the structure of the vegetated roof covering either is in the form of one of a volumetric triangular prism, a volumetric three- or four-sided inverted pyramid, a volumetric cube, a volumetric non-square rectangle, half of or less than half of a volumetric sphere or one or more steps, or has one of a triangular or substantially triangular shape in a side view or a side cross-sectional view, has a square or substantially square shape in a side view or a side cross-sectional view, has a non-square rectangle or substantially non-square rectangle shape in a side view or a side cross-sectional view, has a v-shape or substantially v-shape shape in side view or side cross-sectional view, has an arc or substantially arc-shape in side or side cross-sectional view, is stepped in side or cross-sectional view, or has a concave or convex side or cross-sectional view, each with a completely or partially open top.
(38) The vegetated roof covering according to any one of (1) to (37), wherein vegetated roof covering includes a plurality of individual, separate water catchment portions or areas.
(39) The vegetated roof covering according to any one of (1) to (38), wherein the plurality of individual, separate water catchment portions or areas are either all the same or substantially the same in terms of structure or configuration or have at least one said water catchment portion or area that is different or substantially different in terms of structure or configuration.
(40) The vegetated roof covering according to any one of (1) to (39), wherein the vegetated roof covering consists of a single water catchment portion or area or is comprised of only one water catchment portion or area.
(41) The vegetated roof covering according to any one of (1) to (40), wherein each said water catchment portion or area is modular.
(42) The vegetated roof covering according to any one of (1) to (41), wherein the vegetated roof covering is configured to be attached, permanently or non-permanently, to a sloped roof, a flat-topped roof, a clear-span structure, and/or a standing seam roof.
(43) The vegetated roof covering according to any one of (1) to (42), further comprising one of a sloped roof, a flat-topped roof, a clear span structure, and a standing seam roof
(44) A vegetated roof covering structure configured or constructed to intentionally store or retain at least ½ inch of water over and in direct contact with a layer of moss of the vegetated roof covering structure.
(45) The vegetated roof covering structure according to (44), wherein the vegetated roof covering structure is configured or constructed to store or retain any amount of water from ½ inch to 4 inches of water over and in direct contact with the layer of moss.
(46) The vegetated roof covering structure according to (44) or (45), wherein the vegetated roof covering structure is configured or constructed to store or retain no more than any amount of water from ½ inch to 4 inches of water over and in direct contact with the layer of moss.
(47) The vegetated roof covering structure according to any one of (44) to (46), wherein the vegetated roof covering structure is configured to periodically desiccate, dry or dry out, completely or partially.
(48) The vegetated roof covering structure according to any one of (44) to (47), wherein the operation or function of the vegetated roof covering structure is not impaired by the periodic desiccation, drying, or drying out.
(49) The vegetated roof covering structure according to any one of (44) to (48), wherein the vegetated roof covering structure is configured to store or retain water and to allow the water to escape only via either evaporation or evapotranspiration and only via evaporation or transpiration.
(50) The vegetated roof covering structure according to any one of (44) to (49), wherein the vegetated roof covering structure is configured to store or retain water and to allow the water to escape only via evaporation, then only via evapotranspiration, and then only via transpiration.
(51) The vegetated roof covering structure according to any one of (44) to (50), wherein the vegetated roof covering structure is configured to store or retain water and to allow the water to escape only via evaporation and transpiration and then only via transpiration.
(52) The vegetated roof covering structure according to any one of (44) to (51), wherein the vegetated roof covering structure is configured to store or retain water and to allow the water to escape via either evaporation or evapotranspiration, via evaporation and transpiration, and via controlled release or active detention, the vegetated roof covering structure including a mechanism to perform the controlled release or active detention.
(53) The vegetated roof covering structure according to any one of (44) to (52), wherein the mechanism for controlled release or active detection includes at least one valve drain connecting the vegetated roof covering structure to a drainage system.
(54) The vegetated roof covering structure according to any one of (44) to (53), wherein the vegetated roof covering structure is configured to provide stormwater retention and/or stormwater detention.
(55) The vegetated roof covering structure according to any one of (44) to (54), wherein the vegetated roof covering structure is configured to wick water from an area or portion thereof having gravitational water associated therewith to an area or portion thereof that does not have gravitational water associated therewith.
(56) The vegetated roof covering structure according to any one of (44) to (55), wherein the vegetated roof covering structure includes one or more pieces or portions of capillary or hydrophyllic media or fabric configured to wick water from the area or portion of the vegetated roof covering structure having gravitational water associated therewith to the area or portion of the vegetated roof covering structure that does not have gravitational water associated therewith.
(57) The vegetated roof covering structure according to any one of (44) to (56), wherein the vegetated roof covering structure is configured to have or has an ambient recharge capacity of 60% of storage capacity, 75% of storage capacity, 81% of storage capacity, of 90% of storage capacity, of 95% of storage capacity, of 98% of storage capacity, of at or about 60% to at or about 98%, or of at or about 75% to at or about 98%.
(58) The vegetated roof covering structure according to any one of (44) to (57), wherein the vegetated roof covering structure is configured to have or has a volumetric water storage amount of up to 70% of volume, up to approximately 70% of volume, up to 80% of volume, up to approximately 80% of volume, up to 90% of volume, up to approximately 90% of volume, up to 93% of volume, up to approximately 93% of volume, up to 95% of volume, up to approximately 95% volume, at or about 70% of volume to at or about 95% of volume, or at or about 80% of volume to at or about 95% of volume.
(59) The vegetated roof covering structure according to any one of (44) to (58), wherein the vegetated roof covering structure includes an absorbent media having a thickness of at or about ¼ inch, at or about ½ inch, at or about ¾ inch, at or about 1 inch, at or about 1.25 inch, at or about 1.5 inch, at or about 1.75 inch, or at our about 2 inches or any amount from at or about ¼ inch to at or about 2 inches.
(60) The vegetated roof covering structure according to any one of (44) to (59), wherein the absorbent media has a dry weight that is at or about 10 psf or less, at or about 4 psf or less, any amount from at or about 4 psf to at or about 10 psf, or any amount from at or about 1 psf to at or about 10 psf.
(61) The vegetated roof covering structure according to any one of (1) to (60), wherein the vegetated roof covering structure includes one or more dry components, the one or more dry components, as a whole, having a thickness of at or about ¼ inch, at or about ½ inch, at or about ¾ inch, at or about 1 inch, at or about 1.25 inch, at or about 1.5 inch, at or about 1.75 inch, or at our about 2 inches or any amount from at or about ¼ inch to at or about 2 inches.
(62) The vegetated roof covering structure according to any one of (4) to (61), wherein the one or more dry components, as a whole, having a dry weight that is at or about 10 psf or less, at or about 4 psf or less, any amount from at or about 4 psf to at or about 10 psf, or any amount from at or about 1 psf to at or about 10 psf.
(63) The vegetated roof covering structure according to any one of (44) to (62), wherein the stored or retained water is rainwater or stormwater captured directly.
(64) The vegetated roof covering structure according to any one of (44) to (63), wherein the vegetated roof covering structure comprises a housing having a first area with a first depth and second area with a second depth different from the first depth.
(65) The vegetated roof covering structure according to any one of (44) to (64), wherein the vegetated roof covering structure comprises a housing having a uniform depth.
(66) The vegetated roof covering structure according to any one of (44) to (65), wherein the vegetated roof covering structure comprises a housing which either is in the form of one of a volumetric triangular prism, a volumetric three- or four-sided inverted pyramid, a volumetric cube, a volumetric non-square rectangle, half of or less than half of a volumetric sphere or one or more steps, or has one of a triangular or substantially triangular shape in a side view or a side cross-sectional view, has a square or substantially square shape in a side view or a side cross-sectional view, has a non-square rectangle or substantially non-square rectangle shape in a side view or a side cross-sectional view, has a v-shape or substantially v-shape shape in side view or side cross-sectional view, has an arc or substantially arc-shape in side or side cross-sectional view, is stepped in side or cross-sectional view, or is convex or concave in side or cross-sectional view, each with a completely or partially open top.
(67) The vegetated roof covering structure according to any one of (44) to (66), wherein vegetated roof covering structure includes a plurality of individual, separate water catchment portions or areas.
(68) The vegetated roof covering structure according to any one of (44) to (67), wherein the plurality of individual, separate water catchment portions or areas are either all the same or substantially the same in terms of structure or configuration or have at least one said water catchment portion or area that is different or substantially different in terms of structure or configuration.
(69) The vegetated roof covering structure according to any one of (44) to (68), wherein the vegetated roof structure covering consists of a single water catchment portion or area or is comprised of only one water catchment portion or area.
(70) The vegetated roof covering structure according to any one of (44) to (69), wherein each said housing or water catchment portion or area is modular.
(71) The vegetated roof covering structure according to any one of (44) to (70), wherein the vegetated roof covering structure is configured to be attached, permanently or non-permanently, to a sloped roof, a flat-topped roof, a clear-span structure, and/or a standing seam roof.
(72) The vegetated roof covering structure according to any one of (44) to (71), further comprising one of a sloped roof, a flat-topped roof, a clear span structure, and a standing seam roof.
(73) A vegetated roof covering system comprising a perennial vegetative surface, the vegetated roof covering system having a dry weight of either any value at or about 1 psf to at or about 10 psf or any value at or about 1 psf to at or about 10 psf and is configured or able to retain at least 1.0 gallons of water per square foot, at least 1.2 gallons of water per square foot, no more than 1.0 gallons of water per square foot, no more than 1.2 gallons of water per square foot, no more than 2.0 gallons of water per square foot, at or about 1.0 gallons of water per square foot to at or about 2.0 gallons of water per square foot, or at or about 1.2 gallons of water per square foot to at or about 2.0 gallons of water per square foot, wherein the vegetated roof covering system is configured or able to allow gravitational water to be released as stormwater detention, is configured or allowed to periodically desiccate to support the perennial vegetative surface.
(74) The vegetated roof covering system according to (73), wherein the vegetated roof covering system is configured to allow the water to escape via evaporation, via evapotranspiration, and via transpiration.
(75) The vegetated roof covering system according to (73) or (74), wherein the vegetated roof covering system is configured to allow the water to escape only via evaporation, then only via evaporation and transpiration, and then only via transpiration.
(76) The vegetated roof covering system according to any one of (73) to (75), wherein the vegetated roof covering system is configured to allow the water to escape only via evaporation and transpiration and then only via transpiration.
(77) The vegetated roof covering system according to any one of (73) to (76), wherein the vegetated roof covering system is configured to allow the water to escape via either evaporation or evapotranspiration, and via controlled release or active detention, the vegetated roof covering structure including a mechanism to perform the controlled release or active detention.
(78) The vegetated roof covering system according to any one of (73) to (77), wherein the vegetated roof covering system is configured to provide stormwater retention and/or stormwater detention.
(79) The vegetated roof covering system according to any one of (73) to (78), wherein the vegetated roof covering system is configured to wick water from an area or portion thereof having gravitational water associated therewith to an area or portion thereof that does not have gravitational water associated therewith.
(80) The vegetated roof covering system according to any one of (73) to (79), wherein the vegetated roof covering system includes one or more pieces or portions of capillary or hydrophyllic media or fabric configured to wick water from the area or portion of the roof covering system having gravitational water associated therewith to the area or portion of the roof covering system that does not have gravitational water associated therewith.
(81) The vegetated roof covering system according to any one of (73) to (80), wherein the perennial vegetative surface does not require manmade fertilizers or synthetic nutrients to sustain growth.
(82) The vegetated roof covering system according to any one of (73) to (81), wherein the vegetated roof covering system utilizes a living plant rooting medium that evapotranspirates.
(83) A vegetated roof covering system having a dry weight of either any value at or about 1 psf to at or about 10 psf or any value at or about 1 psf to at or about 10 psf and is configured or able to retain at least 1.0 gallons of water per square foot, at least 1.2 gallons of water per square foot, no more than 1.0 gallons of water per square foot, no more than 1.2 gallons of water per square foot, no more than 2.0 gallons of water per square foot, at or about 1.0 gallons of water per square foot to at or about 2.0 gallons of water per square foot, or at or about 1.2 gallons of water per square foot to at or about 2.0 gallons of water per square foot, and is configured or allowed to periodically desiccate.
(84) The vegetated roof covering system according to (83), wherein the vegetated roof covering system is configured to allow the water to escape only via either evaporation, evapotranspiration, or transpiration.
(85) The vegetated roof covering system according to (83) or (84), wherein the vegetated roof covering system is configured to allow the water to escape only via evaporation, then only via evaporation and transpiration, and then only via transpiration.
(86) The vegetated roof covering system according to any one of (83) to (85), wherein the vegetated roof covering system is configured to allow the water to escape either only via evaporation and transpiration and then only via transpiration or only via transpiration.
(87) The vegetated roof covering system according to any one of (83) to (86), wherein the vegetated roof covering system is configured to allow the water to escape via either evaporation or evapotranspiration and via controlled release or active detention, the vegetated roof covering structure including a mechanism to perform the controlled release or active detention.
(88) The vegetated roof covering system according to any one of (83) to (87), wherein the vegetated roof covering system is configured to provide stormwater retention and/or stormwater detention and/or is configured or allowed to periodically desiccate.
(89) The vegetated roof covering system according to any one of (83) to (88), wherein the vegetated roof covering system is configured to wick water from an area or portion thereof having gravitational water associated therewith to an area or portion thereof that does not have gravitational water associated therewith.
(90) The vegetated roof covering system according to any one of (83) to (89), wherein the vegetated roof covering system includes one or more pieces or portions of capillary or hydrophyllic media or fabric configured to wick water from the area or portion of the roof covering system having gravitational water associated therewith to the area or portion of the roof covering system that does not have gravitational water associated therewith.
(91) The vegetated roof covering system according to any one of (83) to (90), wherein the perennial vegetative surface does not require manmade fertilizers or synthetic nutrients to sustain growth.
(92) The vegetated roof covering system according to any one of (83) to (91), wherein the vegetated roof covering system utilizes a living plant rooting medium that evapotranspirates.
(93) A vegetated roof covering system having a structure configured to retain at least 1.0 gallons of water per square foot, at least 1.2 gallons of water per square foot, no more than 1.0 gallons of water per square foot, no more than 1.2 gallons of water per square foot, no more than 2.0 gallons of water per square foot, at or about 1.0 gallons of water per square foot to at or about 2.0 gallons of water per square foot, or at or about 1.2 gallons of water per square foot to at or about 2.0 gallons of water per square foot and having dry components that as a group do not exceed one-inch in thickness, that do not exceed two inches in thickness, or that have a thickness of at or about one inch to at or about two inches.
(94) The vegetated roof covering system according to any one of (83) to (93), wherein the vegetated roof covering system is configured to allow the water to escape only via either evaporation or evapotranspiration and only via evapotranspiration or transpiration.
(95) The vegetated roof covering system according to any one of (83) to (94), wherein the vegetated roof covering system is configured to allow the water to escape only via evaporation, then only via evaporation and transpiration, and then only via transpiration.
(96) The vegetated roof covering system according to any one of (83) to (95), wherein the vegetated roof covering system is configured to allow the water to escape only via evaporation and transpiration and then only via transpiration.
(97) The vegetated roof covering system according to any one of (83) to (96), wherein the vegetated roof covering system is configured to allow the water to escape via either evaporation or evapotranspiration and via controlled release or active detention, the vegetated roof covering structure including a mechanism to perform the controlled release or active detention.
(98) The vegetated roof covering system according to any of any one of (83) to (97), wherein the vegetated roof covering system is configured to provide stormwater retention and/or stormwater detention and/or is configured or allowed to periodically desiccate.
(99) The vegetated roof covering system according to any one of (83) to (98), wherein the vegetated roof covering system is configured to wick water from an area or portion thereof having gravitational water associated therewith to an area or portion thereof that does not have gravitational water associated therewith.
(100) The vegetated roof covering system according to any one of (83) to (99), wherein the vegetated roof covering system includes one or more pieces or portions of capillary or hydrophyllic media or fabric configured to wick water from the area or portion of the roof covering system having gravitational water associated therewith to the area or portion of the roof covering system that does not have gravitational water associated therewith.
(101) The vegetated roof covering system according to any one of (83) to (100), wherein the perennial vegetative surface does not require artificial addition of fertilizers or nutrients to sustain growth.
(102) The vegetated roof covering system according to any one of (83) to (101), wherein the vegetated roof covering system utilizes a living plant rooting medium that evapotranspirates.
(103) The vegetated roof covering system according to any one of (83) to (102), wherein the dry components include a media at the bottom of a containment device having a thickness of at or about ½ inch.
(104) A vegetated roof covering system comprising: a water catchment housing having an open top and a bottom wall and defining an internal volume; and a vegetative layer anchored to the bottom wall of the water catchment housing at an anchoring interface, wherein the vegetated roof covering system is configured to catch water using the water catchment housing and to intentionally temporarily retain gravitational water above and in direct contact with a portion of the vegetative layer, up to a maximum water fill level defined by the geometry of the water catchment housing.
(105) The vegetated roof covering system according to (104), wherein the vegetative layer is either anchored directly to the bottom wall of the water catchment housing or is anchored indirectly to the bottom wall of the water catchment housing via a root-permeable or anchor layer or section.
(106) The vegetated roof covering system according to (104) or (105), wherein the bottom wall of the wall catchment housing includes one or more pieces or portions of capillary or hydrophyllic media or fabric configured to wick water from the area or portion of the roof covering system having gravitational water associated therewith to the area or portion of the roof covering system that does not have gravitational water associated therewith, and wherein the vegetative layer is anchored directly to the one or more pieces or portions of capillary or hydrophyllic media or fabric.
(107) The vegetated roof covering system according to any one of (104) to (106), wherein the root-permeable or anchor layer or section includes a capillary or hydrophyllic media and/or at least one of mineral and organic materials, and wherein the vegetative layer has a portion anchored directly to the capillary or hydrophyllic media and/or a portion anchored directly to the at least one of mineral and organic materials.
(108) The vegetated roof covering system according to any one of (104) to (107), further comprising a waterproof membrane under the water catchment housing, or wherein the water catchment housing includes the waterproof membrane.
(109) The vegetated roof covering system according to any one of (104) to (108), wherein the water catchment housing is configured to be operative or functional with the bottom wall at a decline from a first containment edge to a second containment edge opposite the first containment edge, the first and/or second containment edges defining the maximum water fill level.
(110) The vegetated roof covering system according to any one of (104) to (109), wherein the water catchment housing is configured to be operative or functional with the bottom wall horizontal or substantially horizontal from a first containment edge to a second containment edge opposite the first containment edge, the first and second containment edges defining the maximum water fill level.
(111) The vegetated roof covering system according to any one of (104) to (110), wherein the water catchment housing is configured to be operative or functional with the bottom wall at a decline from a plurality of containment edges.
(112) The vegetated roof covering system according to any one of (104) to (111), wherein the decline is linear, non-linear, or a combination thereof
(113) The vegetated roof covering system according to any one of (104) to (112), wherein the vegetated roof covering system is configured to periodically desiccate, dry or dry out, completely or partially.
(114) The vegetated roof covering system according to any one of (104) to (113), wherein the vegetated roof covering system is configured to allow the water to escape only via either evaporation or evapotranspiration, only via evapotranspiration, and/or only via transpiration.
(115) The vegetated roof covering system according to any one of (104) to (114), wherein the vegetated roof covering system is configured to allow the water to escape only via evaporation, then only via evapotranspiration, and then only via transpiration.
(116) The vegetated roof covering system according to any one of (104) to (115), wherein the vegetated roof covering system is configured to allow the water to escape only via evaporation and transpiration and then only via transpiration.
(117) The vegetated roof covering system according to any one of (104) to (116), wherein the vegetated roof covering system is configured to allow the water to escape via either evaporation or evapotranspiration and via controlled release or active detention, the vegetated roof covering system including one or more valved drains to perform the controlled release or active detention.
(118) The vegetated roof covering system according to any one of (104) to (117), wherein the vegetated roof covering system is configured to allow the water to escape via passive detention using one or more passive detention structures.
(119) The vegetated roof covering system according to any one of (104) to (118), wherein the vegetated roof covering system is configured to provide stormwater retention, stormwater detention, or stormwater retention and detention.
(120) The vegetated roof covering system according to any one of (104) to (119), wherein the water catchment housing is configured to retain at least ½ inch of water, at least 1 inch of water, at least 1.5 inches of water, at least 2 inches of water, at least 2.5 inches of water, at least 3 inches of water, at least 3.5 inches of water, or at least 4 inches of water above the portion of the vegetative layer.
(121) The vegetated roof covering system according to any one of (104) to (120), wherein the water catchment housing is configured to store no more than ½ inch of water, no more than 1 inch of water, no more than 1.5 inches of water, no more than 2 inches of water, no more than 2.5 inches of water, no more than 3 inches of water, no more than 3.5 inches of water, or no more than 4 inches of water above the portion of the vegetated layer.
(122) The vegetated roof covering system according to any one of (104) to (121), wherein the wall catchment housing is configured to store any amount from ½ inch to 4 inches of water above the portion of the vegetated layer.
(123) The vegetated roof covering system according to any one of (104) to (122), wherein the vegetated surface excludes any vascular plants.
(124) The vegetated roof covering system according to any one of (104) to (123), wherein the portion of the vegetated layer is the entire vegetated layer.
(125) The vegetated roof covering system according to any one of (104) to (124), wherein the portion of the vegetated layer is less than the entire vegetated layer.
(126) The vegetated roof covering system according to any one of (104) to (125), wherein vegetation of the vegetated layer is comprised of, is comprised essentially of consists of, consists essentially of or is selected from the group consisting of at least one of one or more types or varieties of moss, one or more types or varieties of lichen, and/or one or more types or varieties of non-vascular plants.
(127) The vegetated roof covering system according to any one of (104) to (126), wherein vegetation of the vegetated layer is comprised of, is comprised essentially of consists of, consists essentially of, or is selected from the group consisting of at least one of one or more types or varieties of moss, one or more types or varieties of lichen, one or more types or varieties of non-vascular plants, and/or one or more types or varieties of vascular plants.
(128) The vegetated roof covering system according to any one of (104) to (127), wherein vegetation of the vegetated layer is comprised of is comprised essentially of, consists of consists essentially of, or is selected from the group consisting of at least one of one or more types or varieties of moss, one or more types or varieties of lichens, one or more types or varieties of quillwort, Phacetia dubia, Sedum pusillum, Opuntia, Selanginella rupestris, Diamorpha Smallii or Elf Orpine, one or more types or varieties of bryophytes, one or more types or varieties of succulents, one or more types or varieties of cacti, one or more types or varieties of grasses, one or more types or varieties of sedges, and/or one or more types or varieties of wildflowers.
(129) The vegetated roof covering system according to any one of (104) to (128), wherein the vegetated roof covering system either is configured not to be artificially irrigated, does not include an artificial or supplemental irrigation system, or is configured not to operate or function with an artificial or supplemental irrigation system.
(130) The vegetated roof covering system according to any one of (104) to (129), wherein the vegetated roof covering system, wherein the vegetated roof covering system is configured to have or has an ambient recharge capacity of 60% of storage capacity, 75% of storage capacity, 81% of storage capacity, of 90% of storage capacity, of 95% of storage capacity, of 98% of storage capacity, of at or about 60% to at or about 98%, or of at or about 75% to at or about 98%.
(131) The vegetated roof covering system according to any one of (104) to (130), wherein the vegetated roof covering system is configured to have or has a volumetric water storage amount of up to 70% of volume, up to approximately 70% of volume, up to 80% of volume, up to approximately 80% of volume, up to 90% of volume, up to approximately 90% of volume, up to 93% of volume, up to approximately 93% of volume, up to 95% of volume, up to approximately 95% volume, at or about 70% of volume to at or about 95% of volume, or at or about 80% of volume to at or about 95% of volume.
(132) The vegetated roof covering system according to any one of (104) to (131), wherein the root-permeable/anchor layer or section or the capillary or hydrophyllic media or fabric have a thickness of at or about ¼ inch, at or about ½ inch, at or about ¾ inch, at or about 1 inch, at or about 1.25 inch, at or about 1.5 inch, at or about 1.75 inch, or at our about 2 inches or any amount from at or about ¼ inch to at or about 2 inches.

(133) The vegetated roof covering system according to any one of (104) to (132), wherein the root-permeable/anchor layer or section or the capillary or hydrophyllic media or fabric has a dry weight that is at or about 10 psf or less, at or about 4 psf or less, any amount from at or about 4 psf to at or about 10 psf, or any amount from at or about 1 psf to at or about 10 psf.
(134) The vegetated roof covering system according to any one of (104) to (133), further comprising one or more dry components, the one or more dry components, as a whole, having a thickness of at or about ¼ inch, at or about ½ inch, at or about ¾ inch, at or about 1 inch, at or about 1.25 inch, at or about 1.5 inch, at or about 1.75 inch, or at our about 2 inches or any amount from at or about ¼ inch to at or about 2 inches.
(135) The vegetated roof covering system according to any one of (104) to (134), wherein the one or more dry components, as a whole, have a dry weight that is at or about 10 psf or less, at or about 4 psf or less, any amount from at or about 4 psf to at or about 10 psf, or any amount from at or about 1 psf to at or about 10 psf.
(136) The vegetated roof covering system according to any one of (104) to (135), wherein the water catchment housing either is in the form of one of a volumetric triangular prism, a volumetric three- or four-sided inverted pyramid, a volumetric cube, a volumetric non-square rectangle, half of or less than half of a volumetric sphere or one or more steps, or has one of a triangular or substantially triangular shape in a side view or a side cross-sectional view, has a square or substantially square shape in a side view or a side cross-sectional view, has a non-square rectangle or substantially non-square rectangle shape in a side view or a side cross-sectional view, has a v-shape or substantially v-shape shape in side view or side cross-sectional view, has an arc or substantially arc-shape in side or side cross-sectional view, is stepped in side or cross-sectional view, or is concave or convex in side or cross-sectional view, each with a completely or partially open top.
(137) The vegetated roof covering system according to any one of (104) to (136), wherein vegetated roof covering system includes a plurality of individual, separate said water catchment housings.
(138) The vegetated roof covering system according to any one of (104) to (137), wherein the plurality of individual, separate water catchment housings are either all the same or substantially the same in terms of structure or configuration or have at least one said water catchment housing that is different or substantially different in terms of structure or configuration.
(139) The vegetated roof covering system according to any one of (104) to (138), wherein the vegetated roof covering system consists of a single said water catchment housing or is comprised of only one said water catchment housing.
(140) The vegetated roof covering system according to any one of (104) to (139), wherein each said water catchment housing is modular.
(141) The vegetated roof covering system according to any one of (104) to (140), wherein the vegetated roof covering system is configured to be attached, permanently or non-permanently, to a sloped roof, a flat-topped roof, a clear-span structure, and/or a standing seam roof.
(142) The vegetated roof covering system according to any one of (104) to (141), further comprising one of a sloped roof, a flat-topped roof, a clear span structure, and a standing seam roof.
(143) A method comprising providing the vegetated roof covering/covering structure/covering system according to any of any one of (1) to (142).
(144) The method according to any one of (1) to (143), further comprising: receiving water using the vegetated roof covering/covering structure/covering system; allowing gravitational water to pond over the vegetated surface or layer; and allowing the gravitational water to escape from the vegetated roof covering/covering structure/covering system.
(145) A method of making or using the vegetated roof covering/covering structure/covering system according to any of any one of (1) to (142).

Having now described non-limiting embodiments of the disclosed subject matter, it should be apparent to those skilled in the art that the foregoing is merely illustrative and not limiting, having been presented by way of example only. Thus, although particular configurations have been discussed and illustrated herein, other configurations can also be employed. Numerous modifications and other embodiments (e.g., combinations, rearrangements, etc.) are enabled by the present disclosure and are within the scope of one of ordinary skill in the art and are contemplated as falling within the scope of the disclosed subject matter and any equivalents thereto. One or more features of each of the embodiments can be combined, rearranged, omitted, etc., within the scope of the disclosed subject matter to produce additional embodiments. Furthermore, certain features may sometimes be used to advantage without a corresponding use of other features. Accordingly, Applicants intend to embrace all such alternatives, modifications, equivalents, and variations that are within the spirit and scope of the disclosed subject matter.

1. A vegetated roof covering having a structure and configuration to intentionally hold captured water gravitationally within and above a portion of a vegetated surface thereof.

2. The vegetated roof covering according to claim 1, wherein the vegetated roof covering is configured to periodically desiccate, dry or dry out, substantially completely or partially.

3. The vegetated roof covering according to claim 1, wherein the vegetated roof covering is configured to retain or hold water and to allow the water to escape only via evaporation, only via evaporation and transpiration, or only via transpiration; only via evaporation, then only via evaporation and transpiration, and then only via transpiration; or only via evaporation and transpiration and then only via transpiration.

4. The vegetated roof covering according to claim 1, wherein the vegetated roof covering is configured to retain or hold water and to allow the water to escape via either evaporation, evapotranspiration or transpiration, and via controlled release or active detention, the vegetated roof covering including a mechanism to perform the controlled release or active detention.

5. The vegetated roof covering according to claim 1, wherein the vegetated roof covering is configured to allow the water to escape via passive detention.

6. The vegetated roof covering according to claim 1, wherein the vegetated roof covering is configured to wick water from an area or portion thereof having gravitational water to an area or portion thereof without gravitational water.

7. The vegetated roof covering according to claim 1, wherein the vegetated roof covering is configured to store at least ½ inch of water, at least 1 inch of water, at least 1.5 inches of water, at least 2 inches of water, at least 2.5 inches of water, at least 3 inches of water, at least 3.5 inches of water, or at least 4 inches of water above the portion of the vegetated surface.

8. The vegetated roof covering according to claim 1, wherein vegetation of the vegetated surface is comprised of, is comprised essentially of, consists of, consists essentially of, or is selected from the group consisting of at least one of one or more types or varieties of moss, one or more types or varieties of lichen, one or more types or varieties of non-vascular plants, and/or one or more types or varieties of vascular plants.

9. The vegetated roof covering according to claim 1, wherein the vegetated roof covering either is configured not to be artificially irrigated, does not include an artificial or supplemental irrigation system, or is not configured to operate or function with an artificial or supplemental irrigation system.

10. The vegetated roof covering according to claim 1, wherein the vegetated roof covering is configured to have or has a volumetric water storage amount of up to 70% of volume, up to approximately 70% of volume, up to 80% of volume, up to approximately 80% of volume, up to 90% of volume, up to approximately 90% of volume, up to 93% of volume, up to approximately 93% of volume, up to 95% of volume, up to approximately 95% volume, at or about 70% of volume to at or about 95% of volume, or at or about 80% of volume to at or about 95% of volume.

11. The vegetated roof covering according to claim 1, wherein the vegetated roof covering includes one or more dry components, the one or more dry components, as a whole, having a thickness of at or about ¼ inch, at or about ½ inch, at or about ¾ inch, at or about 1 inch, at or about 1.25 inch, at or about 1.5 inch, at or about 1.75 inch, or at our about 2 inches or any amount from at or about ¼ inch to at or about 2 inches.

12. The vegetated roof covering according to claim 11, wherein the one or more dry components, as a whole, having a dry weight that is at or about 10 psf or less, at or about 4 psf or less, any amount from at or about 4 psf to at or about 10 psf, or any amount from at or about 1 psf to at or about 10 psf.

13. The vegetated roof covering according to claim 1, wherein the structure of the vegetated roof covering either is in the form of one of a volumetric triangular prism, a volumetric three- or four-sided inverted pyramid, a volumetric cube, a volumetric non-square rectangle, half of or less than half of a volumetric sphere or one or more steps, or has one of a triangular or substantially triangular shape in a side view or a side cross-sectional view, has a square or substantially square shape in a side view or a side cross-sectional view, has a non-square rectangle or substantially non-square rectangle shape in a side view or a side cross-sectional view, has a v-shape or substantially v-shape shape in side view or side cross-sectional view, has an arc or substantially arc-shape in side or side cross-sectional view, is stepped in side or cross-sectional view, or has a concave or convex side or cross-sectional view, each with a completely or partially open top.

14. The vegetated roof covering according to claims 1, wherein the vegetated roof covering includes a plurality of individual, separate water catchment portions or areas.

15. The vegetated roof covering according to claim 1, wherein the structure of the vegetated roof covering includes:
a water catchment housing having an open top and a bottom wall and defining an internal volume, and
a vegetative layer anchored to the bottom wall of the water catchment housing at an anchoring interface,
wherein the vegetated roof covering system is configured to catch water using the water catchment housing and to intentionally temporarily retain gravitational water above and in direct contact with a portion of the vegetative layer, up to a maximum water fill level defined by the geometry of the water catchment housing.

16. A vegetated roof covering system comprising a perennial vegetative surface, the vegetated roof covering system having a dry weight of either any value at or about 1 psf to at or about 10 psf or any value at or about 1 psf to at or about 10 psf and is configured or able to retain at least 1.0 gallons of water per square foot, at least 1.2 gallons of water per square foot, no more than 1.0 gallons of water per square foot, no more than 1.2 gallons of water per square foot, no more than 2.0 gallons of water per square foot, at or about 1.0 gallons of water per square foot to at or about 2.0 gallons of water per square foot, or at or about 1.2 gallons of water per square foot to at or about 2.0 gallons of water per square foot, wherein the vegetated roof covering system is configured or able to allow gravitational water to be released as stormwater detention, is configured or allowed to periodically desiccate to support the perennial vegetative surface.

17. The vegetated roof covering system according to claim 16, wherein the vegetated roof covering system is configured to allow the water to escape via evaporation, via evapotranspiration, and via transpiration.

18. The vegetated roof covering system according to claim 16, wherein the vegetated roof covering system is configured to allow the water to escape via either evaporation or evapotranspiration, and via controlled release or active detention, the vegetated roof covering structure including a mechanism to perform the controlled release or active detention.

19. The vegetated roof covering system according to claim 16, wherein the vegetated roof covering system is configured to wick water from an area or portion thereof having gravitational water associated therewith to an area or portion thereof that does not have gravitational water associated therewith.

20. A vegetated roof covering system having a structure configured to retain at least 1.0 gallons of water per square foot, at least 1.2 gallons of water per square foot, no more than 1.0 gallons of water per square foot, no more than 1.2 gallons of water per square foot, no more than 2.0 gallons of water per square foot, at or about 1.0 gallons of water per square foot to at or about 2.0 gallons of water per square foot, or at or about 1.2 gallons of water per square foot to at or about 2.0 gallons of water per square foot and having dry components that as a group do not exceed one-inch in thickness, that do not exceed two inches in thickness, or that have a thickness of at or about one inch to at or about two inches.
